(19) United States
(12) Patent Application Publication
(10) Pub. No.: US 2020/0262203 A1
(43) Pub. Date: Aug. 20, 2020

(54) DROPLET DEPOSITION HEAD AND ACTUATOR COMPONENT THEREFOR

(71) Applicant: XAAR TECHNOLOGY LIMITED, Cambridge (GB)

(72) Inventors: Peter MARDILOVICH, Cambridge (GB); Robert Errol MCMULLEN, Cambridge (GB); Subramanian SIVARAMAKRISHNAN, Cambridge (GB)

(73) Assignee: XAAR TECHNOLOGY LIMITED, Cambridge (GB)

(21) Appl. No.: 16/646,039

(22) PCT Filed: Sep. 11, 2018
(86) PCT No.: PCT/GB2018/052576

§ 371 Date: Mar. 10, 2020

(30) Foreign Application Priority Data
Sep. 11, 2017 (GB) 1714595.4

(51) Int. Cl. B41J 2/14

(52) U.S. Cl. CPC B41J 2/14233; B41J 2202/12; B41J 2002/14241; B41J 2002/14491

(57) ABSTRACT

An actuator component for a droplet deposition head, comprising: a plurality of fluid chambers, each fluid chamber being provided with a respective nozzle and a respective piezoelectric actuating element, which is actuable to cause the ejection of fluid from the chamber in question through the corresponding one of the nozzles by deforming a membrane, which bounds, in part, the chamber in question; wherein each piezoelectric actuating element comprises: a piezoelectric member having a top side and an opposing bottom side, the bottom side being nearest to the membrane, the top and bottom sides being spaced apart in a thickness direction; a lower electrode, disposed adjacent said bottom side of the piezoelectric member; an upper electrode, disposed adjacent said top side of the piezoelectric member; wherein each upper electrode comprises: a first layer, which is formed of a first conductive material; a second layer, which is formed of a second conductive material, the first layer being disposed between the second layer and piezoelectric member; wherein at least a portion of the first layer overlies the piezoelectric member when viewed from the thickness direction, this overlying portion of the first layer extending over substantially the whole of the top side of the piezoelectric member and having a length in a length direction, which is a direction perpendicular to the thickness direction in which the extent of the first layer overlying portion is at or near a maximum; wherein at least a portion of the second layer overlies both the first layer and the piezoelectric member when viewed from said thickness direction, this overlying portion of the second layer being formed as a pattern that is shaped so as to accommodate flexing of the piezoelectric actuating element when it is actuated; wherein, as viewed from the thickness direction, the area of the second layer overlying portion is substantially less than half that of the first layer overlying portion; wherein the projection of the second layer overlying portion onto said length of the first layer overlying portion covers at least a majority of said length of the first layer overlying portion.

### FIELD OF THE INVENTION

The present invention relates to droplet deposition heads and actuator components therefor. It may find particularly beneficial application in a printhead, such as an inkjet printhead, and actuator components therefor.

### BACKGROUND TO THE INVENTION

Droplet deposition heads are now in widespread usage, whether in more traditional applications, such as inkjet printing, or in 3D printing, or other materials deposition or rapid prototyping techniques. Accordingly, the fluids may have novel chemical properties to adhere to new substrates and increase the functionality of the deposited material.

Recently, inkjet printheads have been developed that are capable of depositing ink directly onto ceramic tiles, with high reliability and throughput. This allows the patterns on the tiles to be customized to a customer's exact specifications, as well as reducing the need for a full range of tiles to be kept in stock.

In other applications, inkjet printheads have been developed that are capable of depositing ink directly on to textiles. As with ceramics applications, this may allow the patterns on the textiles to be customized to a customer's exact specifications, as well as reducing the need for a full range of printed textiles to be kept in stock.

In still other applications, droplet deposition heads may be used to form elements such as colour filters in LCD or OLED elements displays used in flat-screen television manufacturing.

So as to be suitable for new and/or increasingly challenging deposition applications, droplet deposition heads continue to evolve and specialise. However, while a great many developments have been made, there remains room for improvements in the field of droplet deposition heads.

### SUMMARY

Aspects of the invention are set out in the appended claims.

The following disclosure describes an actuator component for a droplet deposition head, comprising: a plurality of fluid chambers, each fluid chamber being provided with a respective nozzle and a respective piezoelectric actuating element, which is actuable to cause the ejection of fluid from the chamber in question through the corresponding one of the nozzles by deforming a membrane, which bounds, in part, the chamber in question.

Each piezoelectric actuating element comprises: a piezoelectric member having a top side and an opposing bottom side, the bottom side being nearest to the membrane, the top and bottom sides being spaced apart in a thickness direction; a lower electrode, disposed adjacent said bottom side of the piezoelectric member; and an upper electrode, disposed adjacent said top side of the piezoelectric member.

Each upper electrode comprises: a first layer, which is formed of a first conductive material; and a second layer, which is formed of a second conductive material, the first layer being disposed between the second layer and piezoelectric member.

At least a portion of the first layer overlies the piezoelectric member when viewed from the thickness direction, this overlying portion of the first layer extending over substantially the whole of the top side of the piezoelectric member and having a length in a length direction, which is a direction perpendicular to the thickness direction, in which the extent of the first layer overlying portion is at or near a maximum.

At least a portion of the second layer overlies both the first layer and the piezoelectric member when viewed from said thickness direction, this overlying portion of the second layer being formed as a pattern that is shaped so as to accommodate flexing of the piezoelectric actuating element when it is actuated. As viewed from the thickness direction, the area of the second layer overlying portion is substantially less than half that of the first layer overlying portion. In addition, the projection of the second layer overlying portion onto said length of the first layer overlying portion covers at least a majority of said length of the first layer overlying portion.

Said pattern may consist substantially of one or more elongate elements.

Each piezoelectric member and each first layer overlying portion may be elongate in said length direction, thus defining a width direction, which is perpendicular to said length direction and to said thickness direction.

Said pattern may be generally symmetric about an axis that extends in said length direction and that is centred on the piezoelectric member with respect to said width direction. Alternatively, or in addition, said pattern may be generally symmetric about an axis that extends in said width direction and that is centred on the piezoelectric member with respect to said length direction.

As viewed from the thickness direction, each nozzle may be located generally at the centre of the corresponding one of the chambers.

As viewed from the thickness direction, each nozzle may be located generally at the centre of the corresponding one of the piezoelectric members.

The actuator component may further comprise one or more passivation layers. Said one or more passivation layers may be disposed over the second layer, the first layer and the piezoelectric member of each piezoelectric actuating element.

In the event that said pattern consists substantially of one or more elongate elements, a respective aperture may be provided for each elongate element. Each of said apertures may be elongate in said length direction.

Said upper electrode may be formed on said top side of the piezoelectric member.

Said lower electrode may be formed on said bottom side of the piezoelectric member.

The first layer for each piezoelectric actuating element may consist substantially of said overlying portion and, optionally, one or more traces extending away from the piezoelectric member to provide electrical connection of the piezoelectric actuating element in question to drive circuitry. Alternatively, or in addition, the second layer for each piezoelectric actuating element may consist substantially of said overlying portion and, optionally, one or more traces extending away from the piezoelectric member to provide electrical connection of the piezoelectric actuating element in question to drive circuitry.

The following disclosure also describes droplet deposition heads comprising such actuator components. Such droplet deposition heads may further comprise one or more manifold components that are attached to the actuator component. Such droplet deposition heads may, in addition, or instead, include drive circuitry that is electrically connected to the actuating elements, for example by means of electrical traces provided by the actuator component. Such drive circuitry may supply drive voltage signals to the actuating elements that cause the ejection of droplets from a selected group of chambers, with the selected group changing with changes in input data received by the head.

To meet the material needs of diverse applications, a wide variety of alternative fluids may be deposited by droplet deposition heads as described herein. For instance, a droplet deposition head may eject droplets of ink that may travel to a sheet of paper or card, or to other receiving media, such as textile or foil or shaped articles (e.g. cans, bottles etc.), to form an image, as is the case in inkjet printing applications, where the droplet deposition head may be an inkjet printhead or, more particularly, a drop-on-demand inkjet printhead.

Alternatively, droplets of fluid may be used to build structures, for example electrically active fluids may be deposited onto receiving media such as a circuit board so as to enable prototyping of electrical devices.

In another example, polymer containing fluids or molten polymer may be deposited in successive layers so as to produce a prototype model of an object (as in 3D printing).

In still other applications, droplet deposition heads might be adapted to deposit droplets of solution containing biological or chemical material onto a receiving medium such as a microarray.

Droplet deposition heads suitable for such alternative fluids may be generally similar in construction to printheads, with some adaptations made to handle the specific fluid in question.

Droplet deposition heads as described in the following disclosure may be drop-on-demand droplet deposition heads. In such heads, the pattern of droplets ejected varies in dependence upon the input data provided to the head.

### BRIEF DESCRIPTION OF THE DRAWINGS

Reference is now directed to the drawings, in which:

FIG. 1A is an end view of a cross-section through the example embodiment of an actuator component;

FIG. 1B which is a plan view of the actuator component shown in FIG. 1A, taken from above the piezoelectric actuating element and membrane;

FIG. 10 is a cross-sectional view of the actuator component of FIGS. 1A and 1B, taken perpendicular to the length of the chamber;

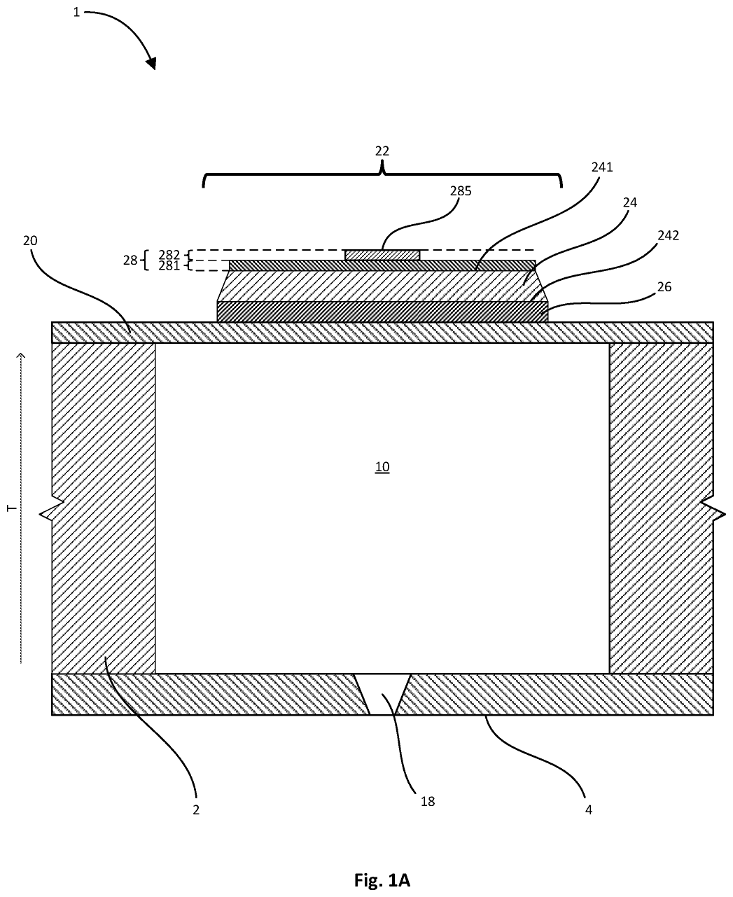

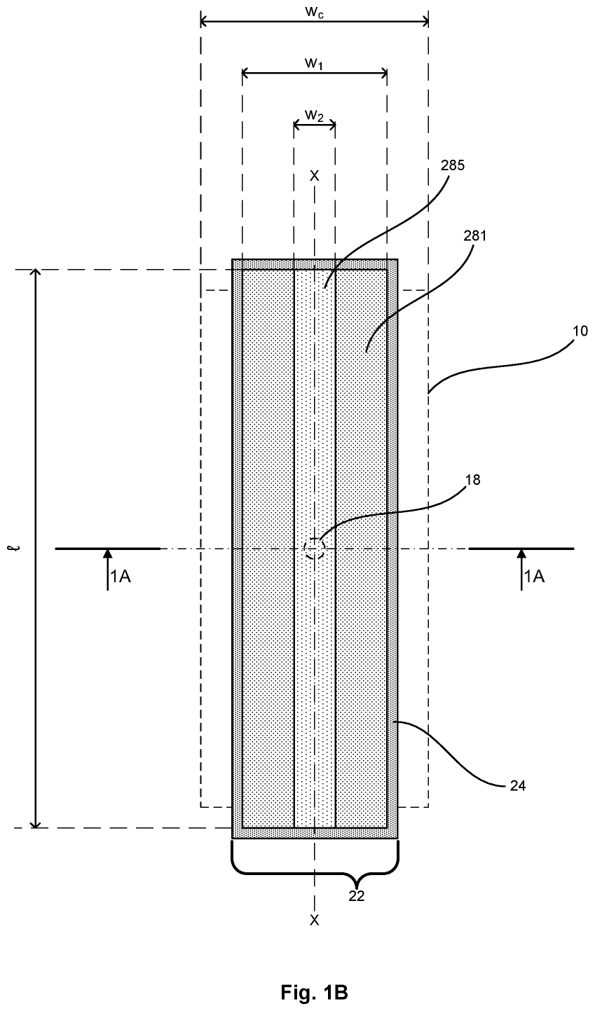

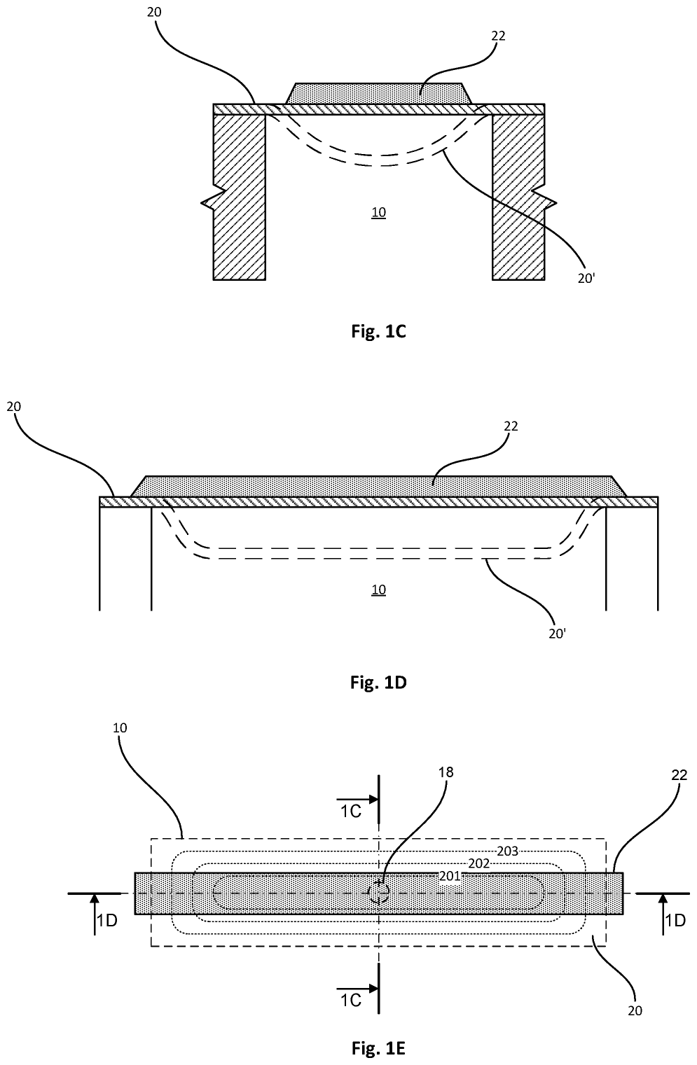

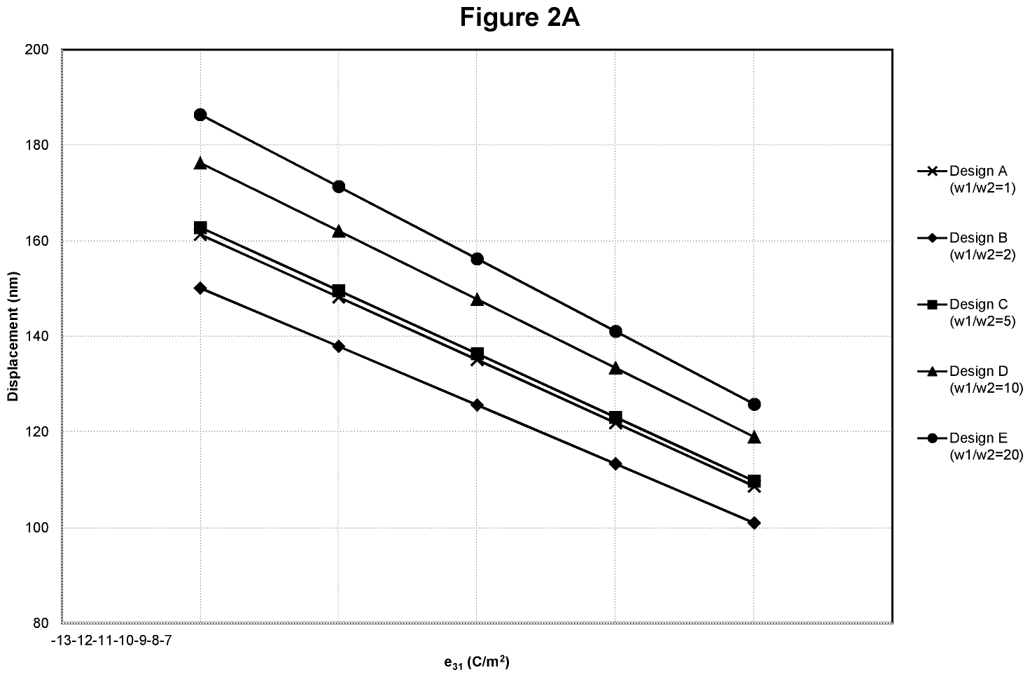

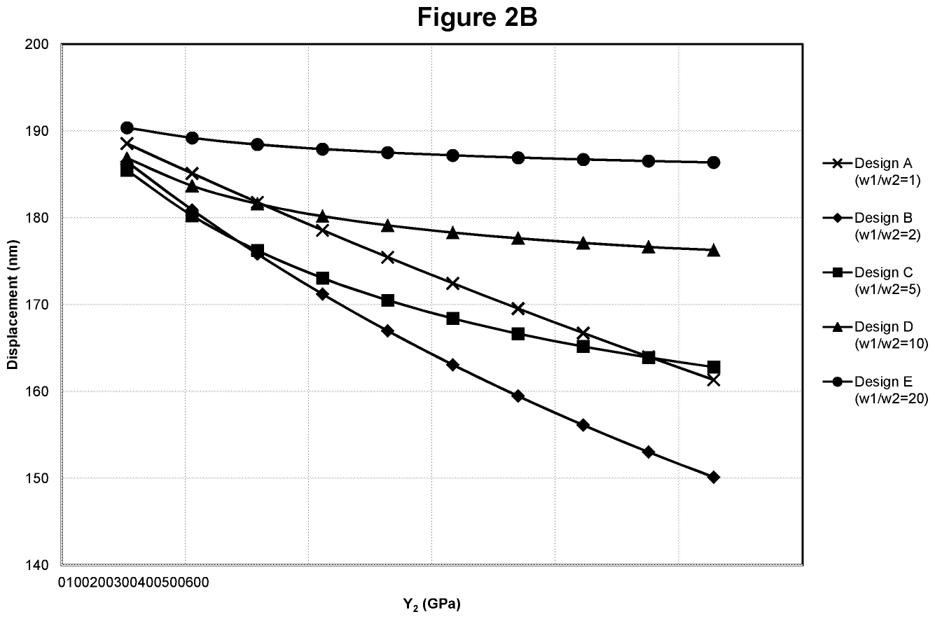

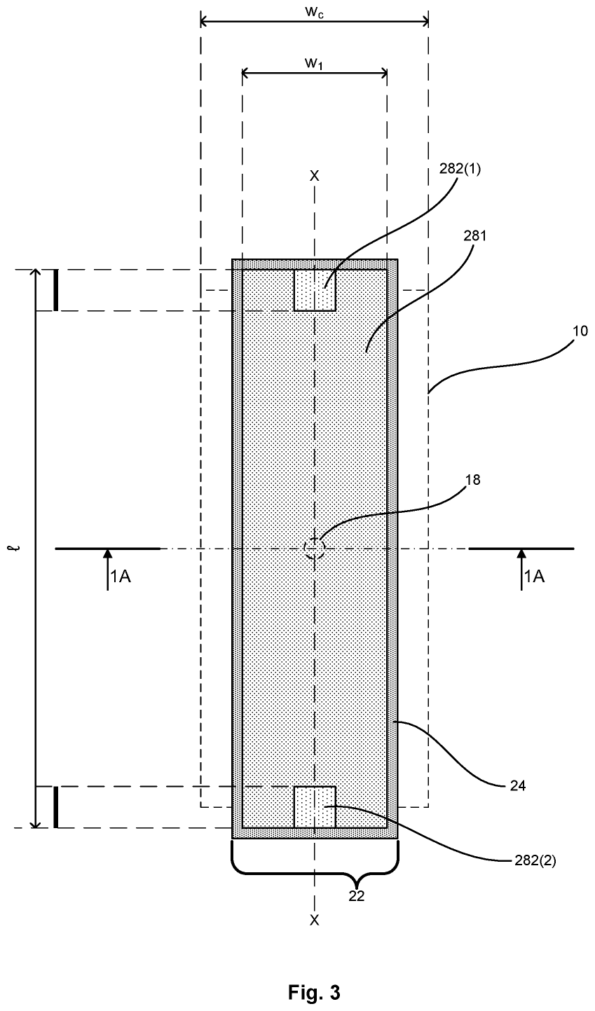

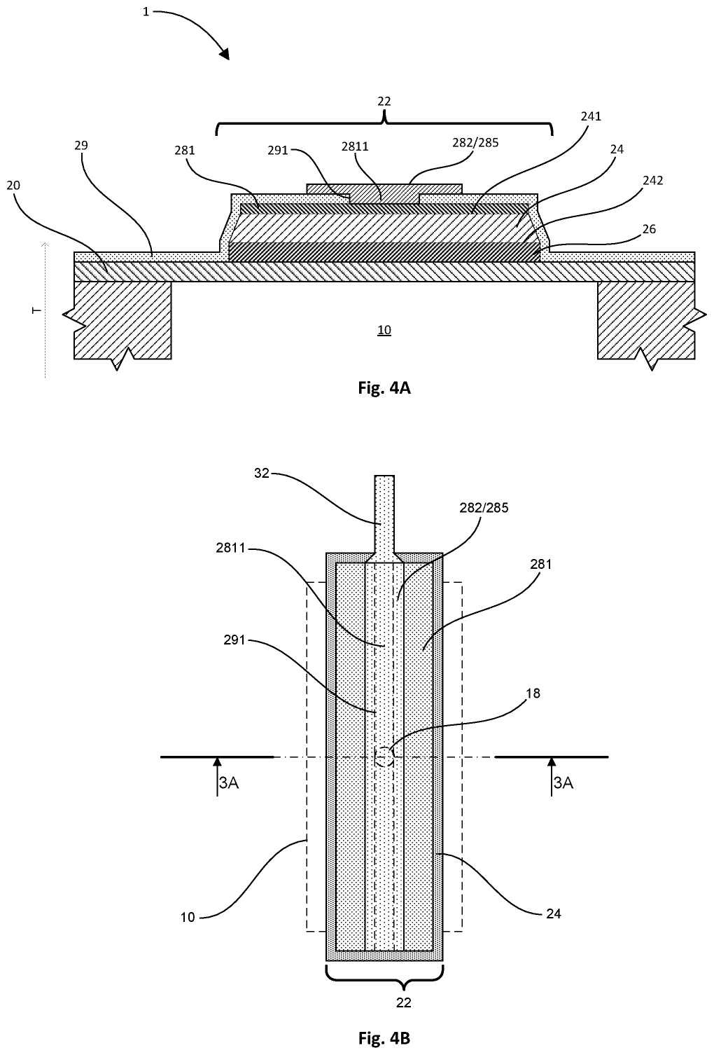

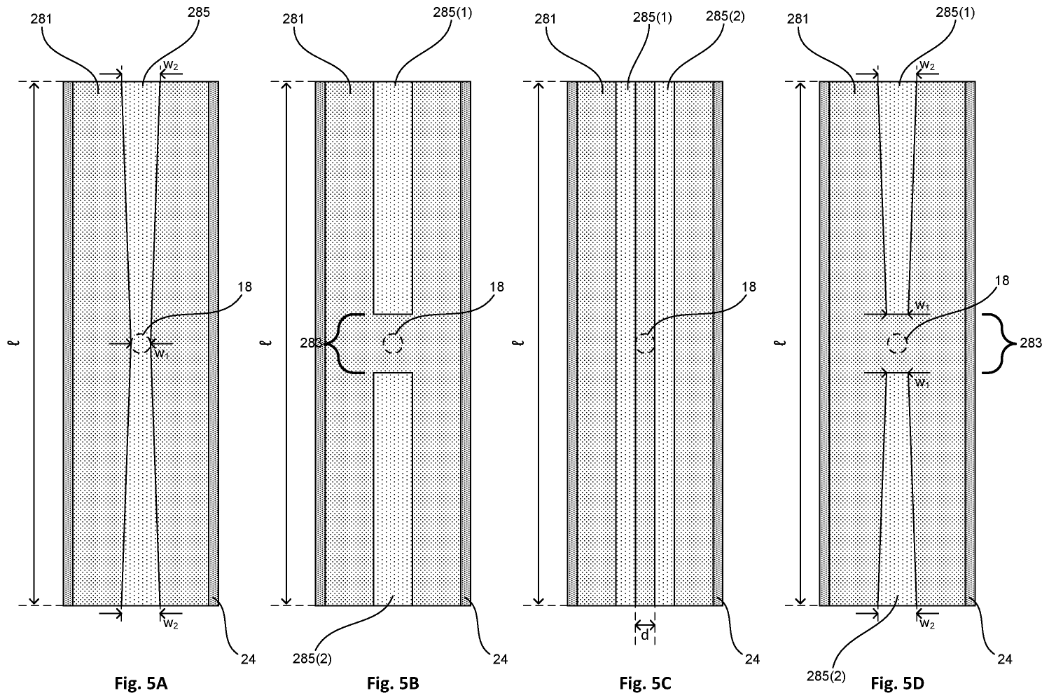

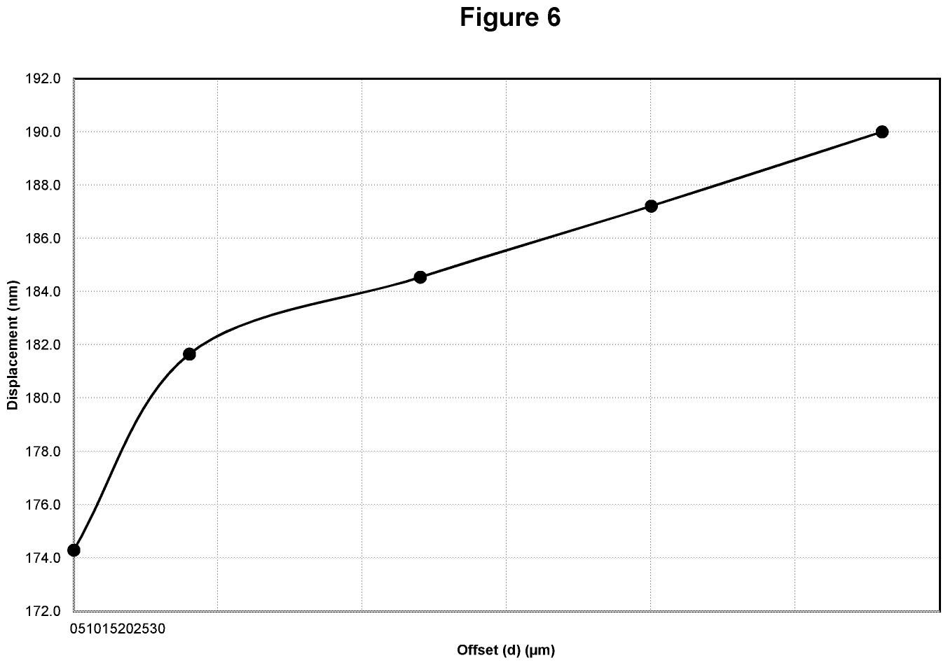

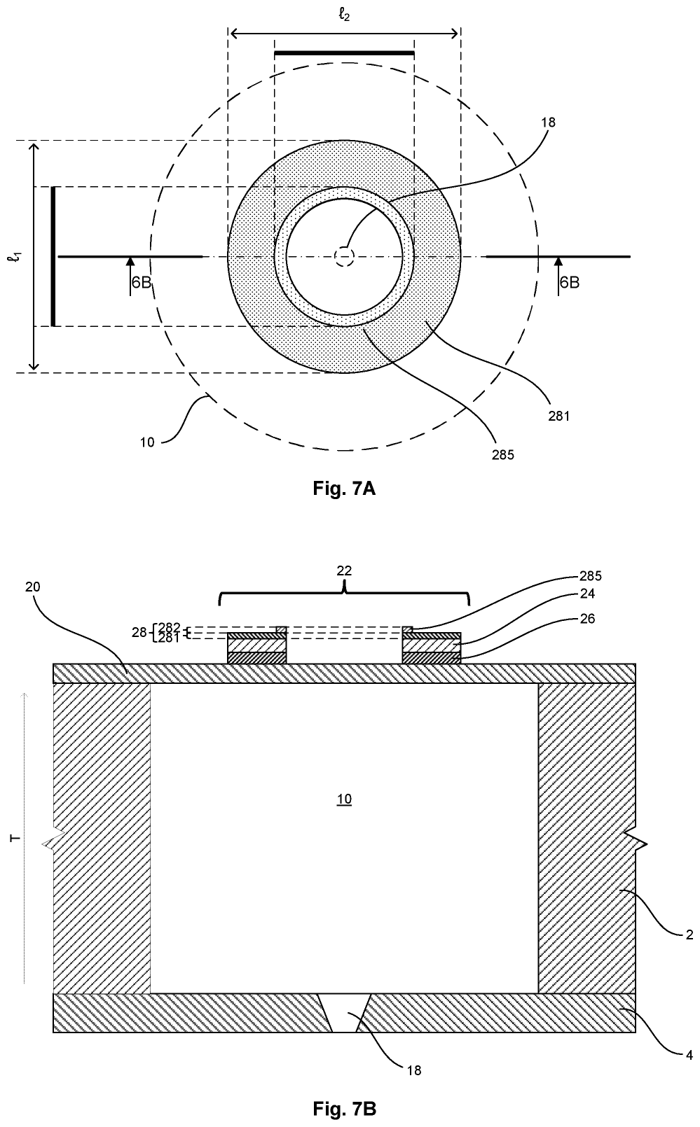

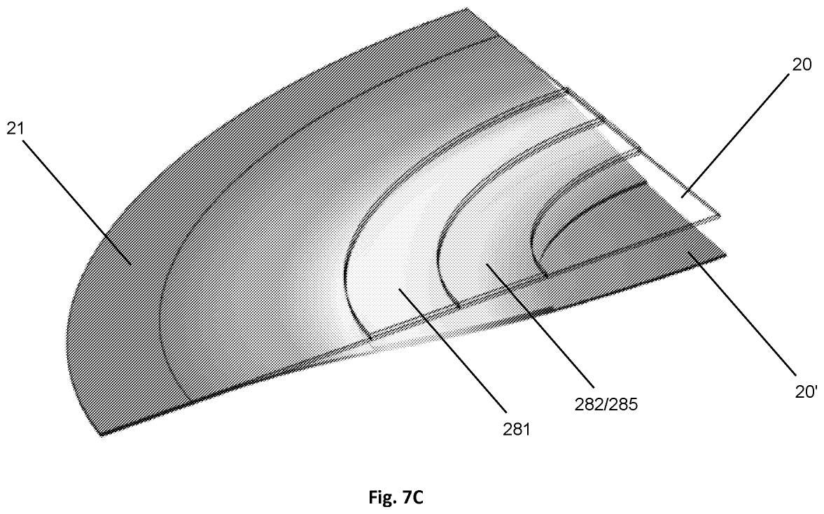

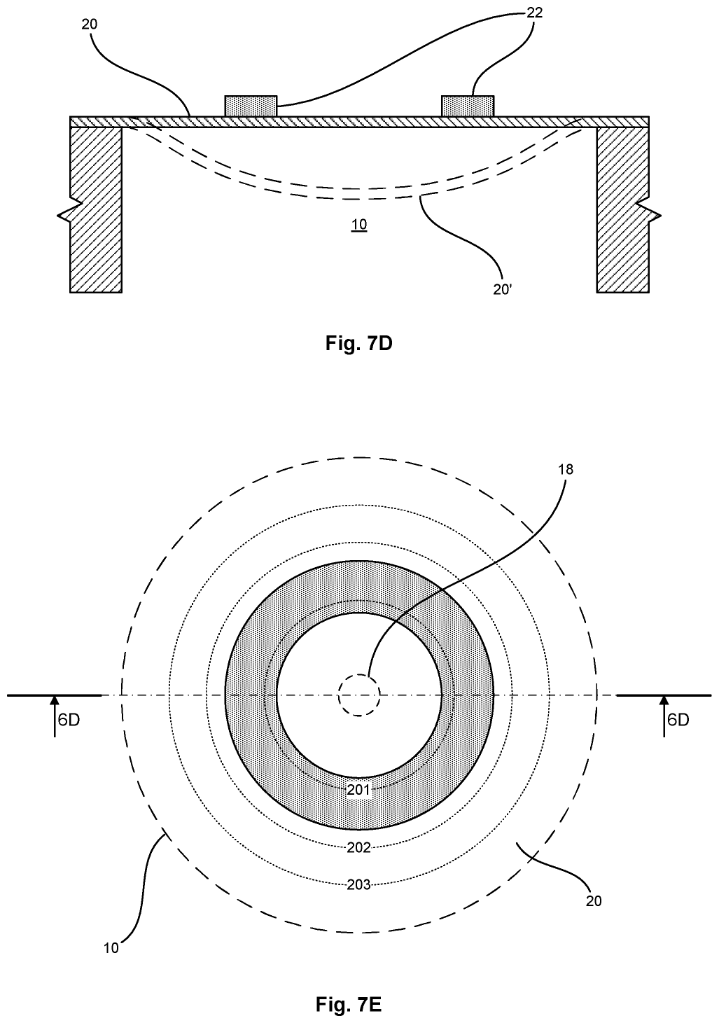

FIG. 1D is a cross-sectional view of the actuator component of FIGS. 1A-1C, taken along the longitudinal axis of the chamber at a location mid-way across the width of the chamber, with the membrane shown in both deformed and undeformed states;

FIG. 1E is a plan view of the actuator component shown in FIGS. 1A-1D that is taken from above the piezoelectric actuating element and that uses contour lines to illustrate the deformation of the membrane;

FIG. 2A is a graph showing the results of performance modelling carried out for a series of actuator component designs each having a different area for the second layer of the upper electrode, for various values of the piezoelectric constant of the piezoelectric member;

FIG. 2B is a graph showing the results of performance modelling carried out for a series of actuator component designs each having a different area for the second layer of the upper electrode, for various values for the Young's modulus of the second layer;

FIG. 3 is a plan view of a contrasting example of an actuator component, which has a far smaller degree of coverage of the length of first layer overlying portion by the projection of the second layer overlying portion, as compared with the actuator component of FIGS. 1A-1E;

FIG. 4A is an end view of a cross-section through a further example embodiment of an actuator component, where the second layer of the upper electrode contacts the first layer over only a portion of its area;

FIG. 4B is a plan view of the actuator component shown in FIG. 4A, from above the piezoelectric actuating element and membrane;

FIGS. 5A-5D show a series of example embodiments of actuator components, each having a different pattern for the second layer overlying portion;

FIG. 6 is a graph showing the results of performance modelling carried out for the design shown in FIG. 5C for various spacings between the two elongate elements of the second layer;

FIG. 7A is a plan view of a still further example embodiment of an actuator component, which has fluid chambers having circular cross-sections and piezoelectric actuating elements that are annular in shape;

FIG. 7B is a view of a cross-section through the fluid chamber of the actuator component of FIG. 7A;

FIG. 7C is a perspective view of a section of the membrane and actuating element of the actuator component of FIGS. 7A and 7B, with the membrane shown in both deformed and undeformed states;

FIG. 7D is a cross-sectional view of the actuator component of FIGS. 7A-7C, taken perpendicular to the plane of the membrane, through the centre of the chamber, with the membrane shown in both deformed and undeformed states;

FIG. 7E is a plan view of the actuator component shown in FIGS. 7A-7D that is taken from above the piezoelectric actuating element and that uses contour lines to illustrate the deformation of the membrane;

FIGS. 8A and 8B are plan views of an actuator component according to a still further example embodiment, which has fluid chambers having circular cross-sections and piezoelectric actuating elements that are annular in shape, but which has a different pattern for the second layer of the upper electrode, as compared with the example embodiment of FIGS. 7A-7E;

FIGS. 9A and 9B are plan views of an actuator component according to a still further example embodiment, which has fluid chambers having circular cross-sections and piezoelectric actuating elements that are annular in shape, but which has a different pattern for the second layer of the upper electrode, as compared with the example embodiments of FIGS. 7A-7E and 8A-8B;

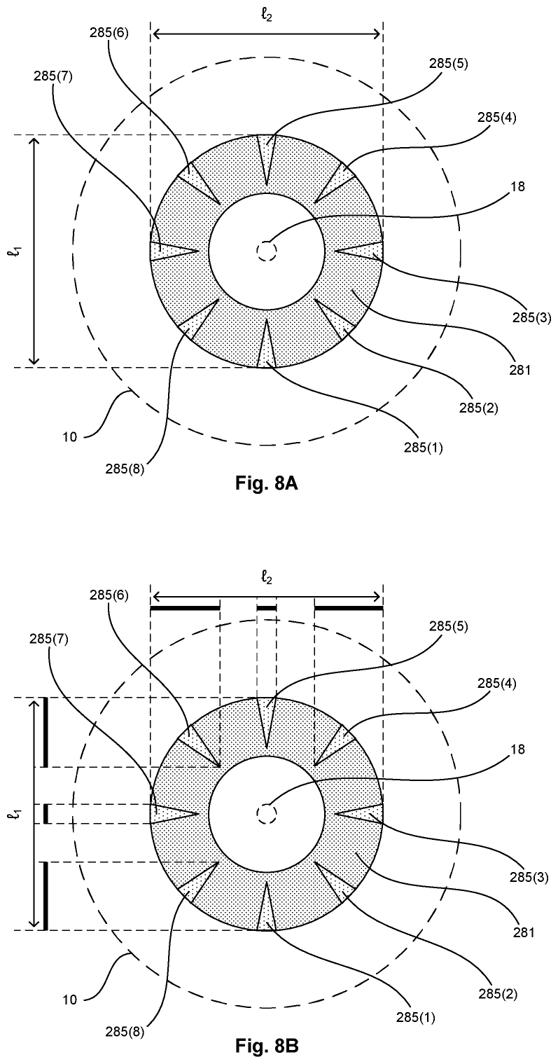

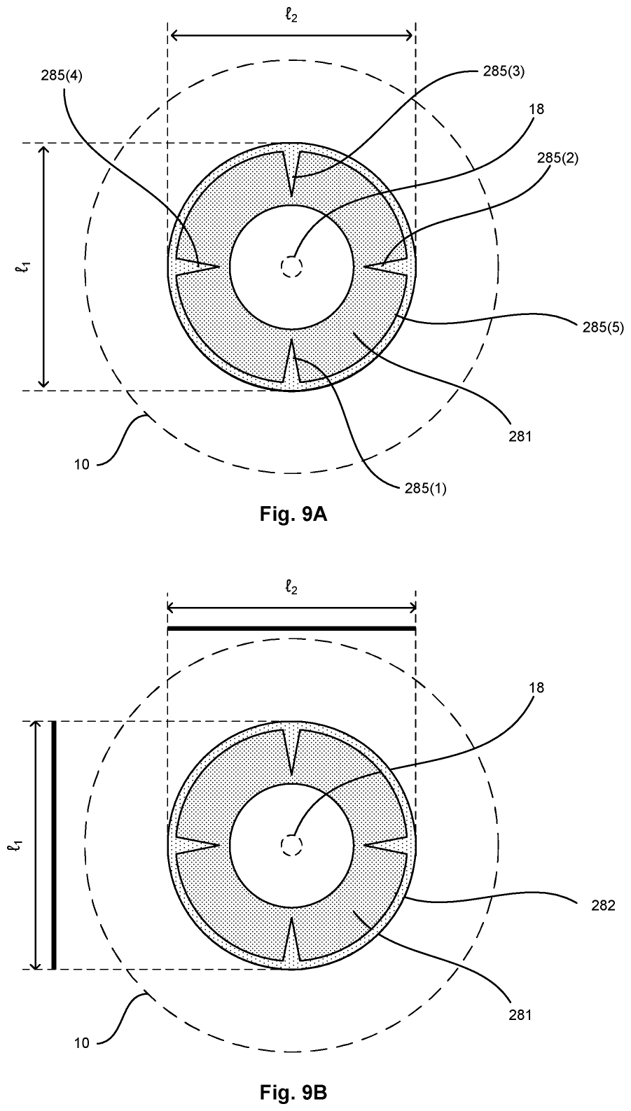

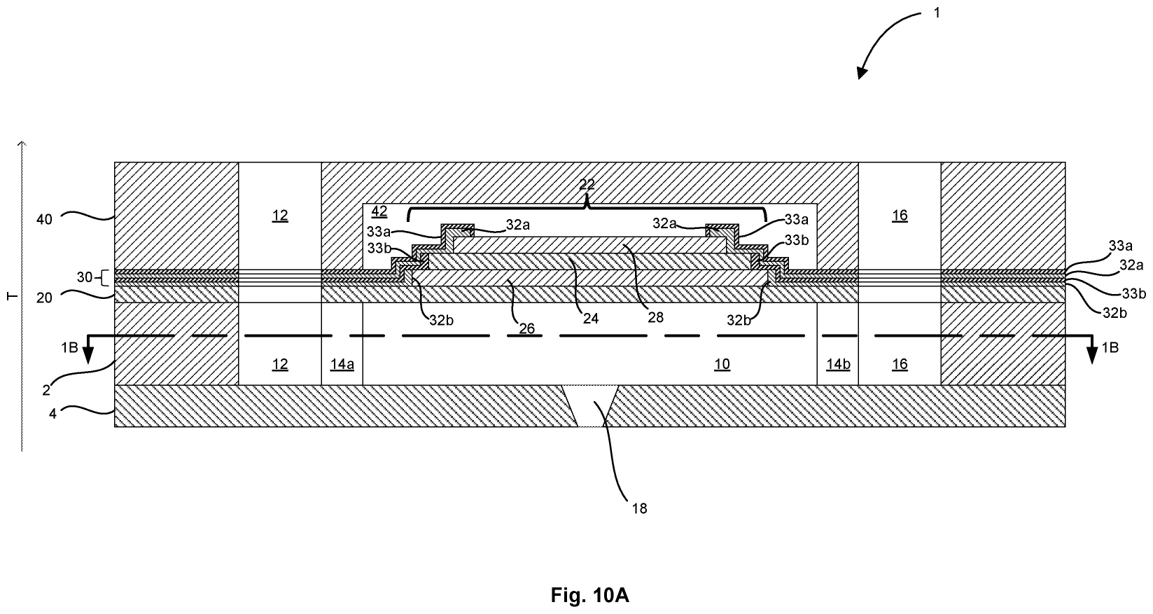

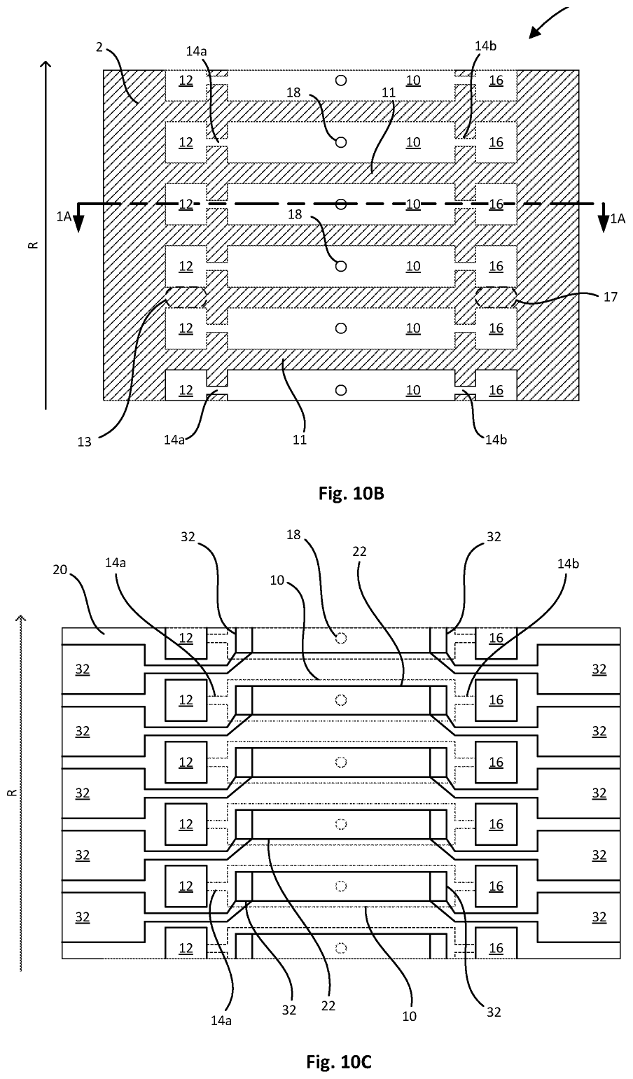

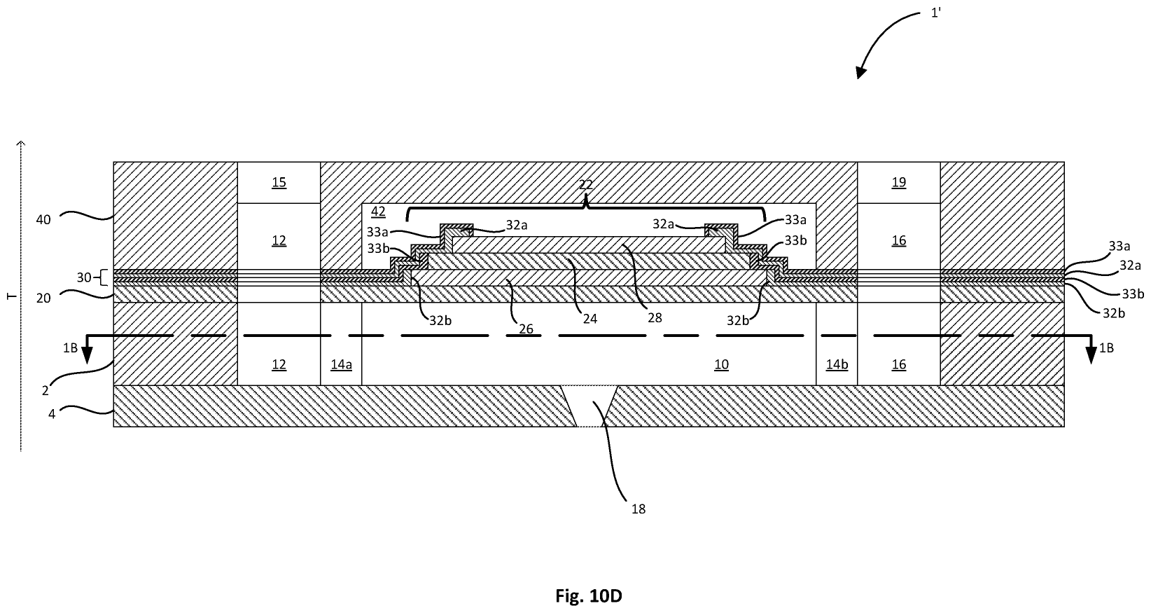

FIG. 10A is a plan view of a cross-section taken along the length of a fluid chamber of an example embodiment of an actuator component, which may include an upper electrode having any of the constructions shown in FIGS. 1A, 4A-4B, and 5A-5D;

FIG. 10B is a cross-section taken in plane 10B indicated in FIG. 10A so as to illustrate the array of fluid chambers;

FIG. 10C is a plan view of the actuator component of FIGS. 10A and 10B from above the membrane; and

FIG. 10D is a plan view of a cross-section taken along the length of a fluid chamber of a modified version of the actuator component of FIGS. 10A-10C.

It should be noted that the drawings are not to scale and that certain features may be shown with exaggerated sizes so that these are more clearly visible.

### DETAILED DESCRIPTION OF THE DRAWINGS

Reference is firstly directed to FIGS. 1A and 1B, which illustrate an actuator component 1 according to a first example embodiment.

More particularly, FIG. 1A shows an end view of a cross-section through the example embodiment of an actuator component 1. Visible in the drawing is a fluid chamber 10, which is provided with a corresponding nozzle 18 and piezoelectric actuating element 22. The piezoelectric actuating element 22 is actuable (for example in response to application of a drive waveform thereto) to cause the ejection of fluid from the chamber 10 through the nozzle 18 by deforming a membrane 20, which is shown clearly in FIG. 1A. As is apparent from FIG. 1A, this membrane 20 bounds part of the chamber 10.

As further shown by FIG. 1A, the piezoelectric actuating element 22 includes a piezoelectric member 24. This piezoelectric member 24 typically consists substantially of piezoelectric material (whereas the piezoelectric actuating element 22 includes a number of elements that are not formed of piezoelectric material).

The piezoelectric member 24 may be provided using any suitable fabrication technique. For example, a sol-gel deposition technique, sputtering and/or ALD may be used to deposit successive layers of piezoelectric material to form the piezoelectric element 24.

The piezoelectric member 24 may, for example, comprise lead zirconate titanate (PZT), but any suitable piezoelectric material may be used.

As is also shown in FIG. 1A, in addition to the piezoelectric member 24, the piezoelectric actuating element 22 includes an upper electrode 28 and a lower electrode 26. The upper and the lower electrode 28, 26 are respectively disposed adjacent the top side 241 and bottom side 242 of the piezoelectric member 24. As may be seen from the drawing, the top and bottom sides 241, 242 oppose one another and are, respectively, the side furthest from and the side nearest to the membrane 20. Further, the top and bottom sides 241, 242 are spaced apart in a thickness direction, which is indicated by the arrow labelled “T” in FIG. 1A.

It will of course be understood that the terms “top”, “bottom”, “upper” and “lower” are merely for convenience and refer to the orientation of the electrodes as depicted in FIG. 1A; they should, in particular, not be taken to imply that the upper electrode 28 must be arranged such that, when the actuator component 1 is in use, it will be located vertically above the lower electrode 26.

During use of the actuator component 1, the upper and lower electrodes 26, 28 may, for example, be utilised to apply a drive waveform to the piezoelectric member 24, causing the deformation of the piezoelectric member 24, and thereby of the membrane 20, and in turn the ejection of a droplet of fluid from the nozzle 18.

In more detail, such deformation of the membrane 20 by the piezoelectric actuating element 22 may cause the ejection of droplets of fluid from the nozzle 18, for example as the result of an increase in the pressure of the fluid within the chamber 10 that ensues from the deformation of the membrane 20.

It should be appreciated that there may be a time-lag between the initial deformation of the membrane 20 and the increase in pressure that causes ejection. For instance, the membrane 20 might initially deform outwardly (that is to say, away from the chamber 10), causing a substantially instantaneous decrease in pressure, and then, a short time afterwards, move inwardly, causing a substantially instantaneous increase in pressure. In some examples, this inward motion may be suitably timed (for example by suitable design of the drive waveform) so as to coincide with the arrival in the vicinity of the nozzle 18 of acoustic waves generated within the chamber 10 by the initial outward movement of the membrane 20. Thus, the acoustic waves may enhance the effect of the increase in pressure caused by the inward motion of the membrane 20.

In further examples, the membrane 20 might simply be actuated such that it initially deforms inwardly towards the chamber 10, thus causing a substantially instantaneous increase in pressure that causes ejection of a droplet. It will be understood that these are merely examples of actuation mechanisms utilising the membrane 20 and actuating element 22 and that other mechanisms may be suitable, depending on the particular application.

Returning now to the subject of the electrodes and, more particularly, the upper electrode 28, it may be seen from FIG. 1A that the upper electrode 28 includes two layers: a first layer 281, which is formed of a first conductive material and which extends over substantially the whole of the top side 241 of the piezoelectric member 24, and a second layer 282, which is formed of a second conductive material and which overlies the first layer 281.

To further explain the relative arrangement of the first and second layers 281, 282 of the upper electrode 28, attention is directed to FIG. 1B, which is a plan view of the actuator component 1 shown in FIG. 1A, from above the piezoelectric actuating element 22 and membrane 20.

As may be seen from FIG. 1B, in the particular example embodiment of FIGS. 1A and 1B, the chamber 10 is elongate, having a longitudinal axis X-X as indicated in FIG. 1B. Nonetheless, this is by no means essential and, as will be appreciated from the description below of the example embodiments of FIGS. 7A-7E, 8A-8B and 9A-9B, the chamber 10 may have a wide range of shapes.

As may also be seen from FIG. 1B, in the particular example embodiment of FIGS. 1A and 1B, the piezoelectric member 24 is also elongate and, specifically, is elongate in the same direction as the chamber 10, extending along longitudinal axis X-X. However, as will be appreciated from the description below of the example embodiments of FIGS. 7A-7E, 8A-8B and 9A-9B, the piezoelectric member 24 may likewise have a wide range of shapes. Further, though convenient, it is by no means essential that, where the piezoelectric member 24 and chamber 10 are both elongate, that their longitudinal axes are parallel. Moreover, it should be understood that an elongate piezoelectric member 24 may be employed even in cases where the chamber 10 is not itself elongate.

FIG. 1B shows clearly how the first layer 281 extends over substantially the whole of the top side 241 of the piezoelectric member 24. It will be understood that, as a result, only the chamfered sides and ends of the piezoelectric member 24 are visible in the plan view of FIG. 1B.

Further, because the piezoelectric member 24 of the example embodiment of FIGS. 1A and 1B is elongate, the first layer 281, as a result of extending over substantially the whole of its top side 241, is similarly elongate, having a length direction (the direction in which its extent, perpendicular to the thickness direction T, is greatest) that extends along longitudinal axis X-X. As indicated in FIG. 1B, the first layer 281 has a length [symbol] in this length direction and a width w₁ in a width direction, perpendicular to the length direction

More generally, a possible consequence of the first layer 281 extending over substantially the whole of the top side 241 of the piezoelectric member 24 is that current crowding effects may be reduced: a generally constant current density may be achieved over substantially the whole of the top side 241 of the piezoelectric member 24. Current crowding can lead to localized overheating and formation of “thermal hot spots”, in extreme cases leading to thermal runaway.

In certain examples, the first layer 281 may provide additional functionality, for example as a consequence of suitable selection of the conductive material from which the first layer 281 is formed (the first conductive material).

To give one example of such additional functionality, the first layer 281 may serve as an oxygen vacancy sink layer. In the absence of such an oxygen sink layer, such oxygen vacancies may, in some cases, accumulate at the interface between the piezoelectric member 24 and the upper electrode 28. Empirically, such an accumulation of oxygen vacancies is often associated with polarization fatigue: in devices exhibiting polarization fatigue, lower oxygen concentration is often found near the electrodes, indicating an increase in oxygen vacancy concentration near the piezoelectric member 24/electrode 28 interface.

Particularly (but not exclusively) where the first layer 281 serves as an oxygen barrier layer, it may be appropriate for the first conductive material to be a metal oxide. It is thought that such metal oxides may act as a sink for oxygen vacancies, preventing their migration to other layers of the device, such as the second layer 282. Examples of suitable metal oxides include RuOₓ, RhOₓ (which may be particularly suitable as a first layer 281 material where the second layer 282 material is Pt), IrO₂ (which may be particularly suitable as a first layer 281 material where the second layer 282 material is Ir), La₁₋ₓSrₓCoO₃ (LSCO), SrRuO₃ (SRO), and LaNiO₃ (LNO).

To give another example of additional functionality provided by the first layer 281, where the piezoelectric member 24 consists of a piezoelectric material comprising lead (such as PZT, PMT-PT or PZT-PT), the first layer 281 may serve as a barrier to lead diffusion.

Indeed, it has been posited that lead diffusion is related to diffusion of oxygen vacancies, since it is often found that when Pb is depleted from the piezoelectric/electrode interface, oxygen vacancies are formed in proportion to the Pb loss according to Pb₁₋ₓ(Zr,Ti)O₃₋ₓ.

Accordingly, where the first layer 281 serves as a lead diffusion barrier, it may be appropriate for the first conductive material to be a metal oxide, such as RuOₓ, Pt/RhOₓ, IrO₂/Ir, La₁₋ₓSrₓCoO₃ (LSCO), SrRuO₃ (SRO), and LaNiO₃ (LNO).

These two specific examples of functionality for the first layer 281 may be viewed as instances of a more general example of functionality for the first layer 281, whereby the first layer 281 acts as a vacancy trapping layer. Again, in such cases it may be appropriate for the first conductive material to be a metal oxide (such as one of those mentioned above). However, it is by no means essential for the first conductive material to be a metal oxide in order for the first layer 281 to act as a vacancy trapping layer.

Though in several of the examples described above the first conductive material is described as being a metal oxide, it should be understood that this is not essential and that any suitable material could be employed. Accordingly, the first conductive material could comprise materials such as iridium (Ir), ruthenium (Ru), platinum (Pt), nickel (Ni), aluminium (Al), manganese (Mn) and/or gold (Au).

In terms of manufacture, the first layer 281 may be formed using any suitable technique, such as sputtering and/or vapour deposition techniques.

Turning now to the second layer 282, this will, in many embodiments, be formed from a conductive material (the second conductive material) that is different to the first conductive material (that from which the first layer 281 is formed). This may, for example, allow for the first and second layers 281, 282 to provide different functionality to the actuator component. For instance, while the first conductive material may be selected so that the first layer 281 provides one of the functions listed above (or some other function), the second conductive material may provide some other useful functionality. One notable example is that the second conductive material may be selected so as to have greater conductivity as compared with the first conductive material. Hence (or otherwise), the second conductive material could comprise materials such as iridium (Ir), ruthenium (Ru), platinum (Pt), nickel (Ni), aluminium (Al) and/or gold (Au), or a suitable alloy. Such materials may particularly (but not exclusively) be utilised in the case where the first conductive material is a metal oxide.

Nonetheless, in some cases (e.g. with certain conductive materials) it may be appropriate to provide an actuator component where the first and second conductive materials are the same. As will be appreciated from the discussion below, embodiments with first and second layers 281, 282 as described herein may prove useful even where the first and second conductive materials are the same, for example as a result of mechanical factors.

In terms of manufacture, the second layer 282 may, for example, be formed using similar techniques to those listed above with reference to the first layer 281. Thus, sputtering and/or vapour deposition techniques might be utilised. However, it will be understood that any suitable technique may be employed.

Turning now to the lower electrode 26, this may comprise any suitable material, such as iridium (Ir), ruthenium (Ru), platinum (Pt), nickel (Ni) iridium oxide (Ir₂O₃), Ir₂O₃/Ir, aluminium (Al) and/or gold (Au). The lower electrode 26 may be formed using any suitable techniques, such as, for example, sputtering and/or vapour deposition techniques.

Further, though the above description has emphasised the multiple layers of the upper electrode 28 (namely, the first and second layers 281, 282 of the upper electrode 28) and though the lower electrode 26 is shown generically as a single layer in FIG. 1A, this should in no way be taken to imply that it is essential that the lower electrode 26 be formed as a single layer. It should accordingly be understood that, in some embodiments, the lower electrode 26 may formed of multiple layers of different materials.

Turning now to the nozzle 18 for the chamber 10, as is apparent from FIG. 1A, in the particular example embodiment shown this is located generally at the centre of the chamber 10, with respect to the chamber's length direction (indicated in FIG. 1B by longitudinal axis X-X). However, it should be appreciated that in other examples the nozzle 18 may be provided in a different location, such as at an end of the chamber 10 (e.g. at an end with respect to the length of the chamber).

In terms of manufacture, the nozzles 18 may be formed using any suitable process such as chemical etching, DRIE, or laser ablation.

In the example embodiment illustrated in FIGS. 1A and 1B, the nozzle 18 is tapered such that its diameter decreases from its inlet to its outlet. The diameter of the nozzle outlet may, for example, be between 15 μm and 100 μm (though in some applications a diameter outside this range may be appropriate).

The taper angle of the nozzle 18 may be substantially constant, as shown in FIG. 1A, or may vary between the inlet and the outlet. For instance, the nozzle 18 may have a greater taper angle at its inlet than at its outlet (or vice versa).

In other examples, the nozzle 18 may not be tapered, having a substantially constant diameter between its inlet and outlet.

While it may be noted that in the example embodiment shown in FIGS. 1A and 1B substantially the whole of the second layer 282 overlies both the first layer 281 and the piezoelectric member 24 (as viewed from the thickness direction T), it should be appreciated that, in other examples, portions of the second layer 282 may extend beyond the first layer 281 (again, as viewed from said thickness direction T) and the piezoelectric member 24. Such portions may, for instance, join with traces 32 that extend over membrane 20 and provide electrical connection of the upper electrode 28, and thus of the piezoelectric member 24, to drive circuitry. As will be discussed below with reference to FIGS. 4A-4B, the second layer 282 may in some cases be integrally formed and/or contiguous with such traces 32.

It may similarly be noted that in the example embodiment shown in FIGS. 1A and 1B, the whole of the first layer 281 overlies the piezoelectric member 24 (as viewed from the thickness direction T). However, it should be appreciated that, in other examples, portions of the first layer 281 could extend beyond the piezoelectric member 24 (again, as viewed from said thickness direction T). For instance, a portion of the first layer 281 might extend over part of the membrane 20 adjacent the piezoelectric member 24.

The inventors consider that the configuration of that portion of the second layer 282 which overlies both the first layer 281 and piezoelectric member 24 (which will be referred to below as the “second layer overlying portion” and which corresponds in the example embodiment of FIGS. 1A and 1B to substantially the whole of the second layer 282) is nonetheless of particular importance. Similarly, they consider that the configuration of that portion of the first layer 281 which overlies the piezoelectric member 24 (which will be referred to below as the “first layer overlying portion” and which corresponds in the example embodiment of FIGS. 1A and 1B to substantially the whole of the first layer 281) is likewise of particular importance. More particularly, the design of the second layer 282 overlying portion relative to the first layer 281 overlying portion is considered to be of particular importance and will now be described.

In more detail, through extensive testing the inventors have determined that, by suitable design of the first layer 281 overlying portion and the second layer 282 overlying portion, a high level of efficiency may be afforded to the piezoelectric actuating element 22 and thus to the actuator component 1 as a whole. It should be appreciated that even relatively minor gains in efficiency, for example of the order of a few percent, may significantly extend the lifetime of the piezoelectric actuating elements and thus the actuator component 1.

More specifically, the testing carried out by the inventors indicates that a significant factor in affording such a high level of efficiency to the piezoelectric actuating element 22 is the ratio of the area of the second layer 282 overlying portion (as seen from the thickness direction T) to the area of the first layer 281 overlying portion. More particularly, they have determined that, in many cases, configuring the upper electrode 28 such that the area of the second layer 282 overlying portion is a small minority of the area of the first layer 281 overlying portion may afford high efficiency to the actuating element 22.

As is apparent from a comparison of FIGS. 1A and 1B, the second layer 282 overlying portion may be considered as being formed as a pattern. In the particular example embodiment of FIGS. 1A and 1B, this pattern simply consists of a single elongate element 285, which is elongate in the length direction of the first layer 281 overlying portion (indicated in FIG. 1B by longitudinal axis X-X) and may be described as an elongate strip of the second conductive material.

In a first series of such tests, computational modelling was carried out for a series of actuator component designs generally of the same design as that shown in FIGS. 1A and 1B, but with each design having a different width w₂ for the elongate element 285 (as measured in the same width direction as the first layer 281 overlying portion, i.e. perpendicular to longitudinal axis X-X in FIG. 1B). The widths of the chamber 10, first layer 281 overlying portion and elongate conductive element 285 (respectively, w_{c}, w₁, w₂) are illustrated clearly in FIG. 1B.

For each of the series of designs, the length of the elongate element 285 was equal to the length [symbol] of the first layer 281 in its length direction (indicated by longitudinal axis X-X in FIG. 1B). The width w₁ and length [symbol] of the first layer 281 overlying portion remained the same for all designs and, as may be appreciated from FIGS. 1A and 1B, are such that the first layer 281 overlying portion extends over substantially the whole of the top side of the piezoelectric member 24.

In this way, the area of the second layer 282 overlying portion was progressively varied over the series of designs, while the area of the first layer 281 overlying portion remained the same.

In addition to varying the width w₂ of the elongate element 285, the thickness of the elongate element 285 was also varied. More particularly, the thickness was varied in inverse proportion to the variation in width w₂. It should be appreciated that this results in the cross-sectional area (taken perpendicular to the length direction, indicated in FIG. 1B by longitudinal axis X-X), and thus the conductivity, of the elongate element 285 remaining the same for all designs. This allows the mechanical effects of the variation in width of the elongate element 285 to be more easily discriminated from other effects and studied.

Reference is now directed to FIG. 2A, which is a graph showing the results of performance modelling carried out for such a series of actuator component designs. Specifically, FIG. 2A shows the amount of displacement of the membrane 20 for each such design, for various values for the piezoelectric constant e_{31,f} of the piezoelectric member 24 with a constant electric field strength of 10V/μm being applied.

As is apparent from FIG. 2A, five designs—labelled A, B, C, D, and E—were studied. In Design A, the elongate element 285 had a width value that was equal to that of the first layer 281 overlying portion, whereas in Designs B, C, D, and E the elongate element 285 had widths that were, respectively, ½, ⅕, 1/10 and 1/20 this width. Conversely, while in Design A the elongate element 285 had a thickness equal to that of the first layer 281 overlying portion, in Designs B, C, and D the elongate element 285 had thicknesses that were, respectively, 2 times, 5 times, 10 times and 20 times greater.

In the designs modelled, the first conductive material (that from which the first layer 281 is formed) was Iridium oxide and the second conductive material (that from which the second layer 282 is formed) was Iridium. Nonetheless, as will be discussed below with reference to FIG. 2B, it is expected that broadly similar trends may be observed with other appropriate conductive materials.

As is apparent from FIG. 2A, an initial decrease in the width w₂ of the elongate element 285 from a value equal to that of the first layer 281 overlying portion (Design A) to a value half that of the first layer 281 overlying portion (Design B) leads to a lower displacement of the membrane 20. However, as the width of the elongate element 285 is decreased further, to a value ⅕th that of the first layer 281 overlying portion (Design C), performance in terms of membrane displacement recovers to the level of Design A. With a still further decrease in the width of the elongate element 285, to a value that is 1/10th that of the first layer 281 overlying portion (Option C) performance in terms of membrane displacement is improved over Option A. With yet a further decrease in the width of the elongate element 285, to a value that is 1/20th that of the first layer 281 overlying portion (Option E) still further improvements in performance in terms of membrane displacement are seen. In all Designs, where the width is decreased compared to a previous Design, there is a corresponding increase in the thickness of the elongate element 285.

The results in FIG. 2A therefore indicate that, when the area of the second layer 282 overlying portion (as viewed from the thickness direction T) is a small minority of that of the first layer 281 overlying portion, a high level of efficiency may be afforded to the piezoelectric actuating element 22.

Further modelling was carried out to investigate the effect of the Young's modulus of the material of the elongate element 285 on the amount of displacement produced by the piezoelectric actuating element 22. The results of such modelling are shown in FIG. 2B.

More particularly, FIG. 2B shows the amount of displacement of the membrane 20 for each of Designs A-E, for various values for the Young's modulus of the elongate element 285. As may be seen, a broadly similar trend to those described above with reference to FIG. 2A is seen across most values of the Young's modulus. Specifically, an initial decrease in the width w₂ of the elongate element 285 from a value equal to that of the first layer 281 overlying portion (Design A) to a value half that of the first layer 281 overlying portion (Design B) leads to lower displacement of the membrane 20. However, as the width of the elongate element 285 is decreased further to a value ⅕th that of the first layer 281 overlying portion (Design C), performance in terms of membrane displacement recovers—at least for cases where the Young's modulus of the elongate element 285 is greater than about 150 GPa. With a still further decrease in the width of the elongate element 285 to a value that is 1/10th that of the first layer 281 overlying portion (Design D), performance in terms of membrane displacement then improves. Furthermore, such improvement is observed for a wide range of Young's moduli. With yet a further decrease in the width of the elongate element 285 to a value that is 1/20th that of the first layer 281 overlying portion (Option E), still further improvements in performance in terms of membrane displacement are seen and, moreover, are seen at substantially all Young's moduli. As before, where the width of the elongate element 285 is decreased compared to a previous Design, there is a corresponding increase in the thickness of the elongate element 285.

The results in FIG. 2B therefore provide further evidence that, when the area of the second layer 282 overlying portion (as viewed from the thickness direction T) is a small minority of that of the first layer 281 overlying portion, a high level of efficiency may be afforded to the piezoelectric actuating element 22. Moreover, the results indicate that this trend is true for a wide range of Young's moduli.

Though the modelling, the results from which are shown in FIGS. 2A-2B, involved varying the width w₂ of the elongate element 285, it should be understood that this is but one way of varying the area of the second layer 282 overlying portion and that similar trends may be expected where, for example, the length of such an elongate element 285 is varied in addition to or instead of the width w₂. Further, as will be discussed below with reference to FIGS. 5A-5D, 7A-7E, 8A-8B and 9A-9B patterns more complex than the single elongate element 285 shown in FIGS. 1A and 1B may be utilised for the second layer 282 overlying portion.

Returning now to FIG. 1B, it may be noted that the projection of the second layer 282 overlying portion onto the length [symbol] of the first layer overlying portion 281 (which in FIG. 1B is parallel to longitudinal axis X-X) covers substantially the whole of length [symbol] A possible consequence of the projection of the second layer 282 overlying portion covering a large amount of the length of the first layer 281 overlying portion is that it avoids significant additional resistance arising from the current spreading from the second layer 282 to the first layer 281. A lower degree of coverage may, in contrast, lead to substantial spreading resistance which will cause additional voltage drop.

While in the example embodiment of FIGS. 1A and 1B, the projection of the second layer 282 overlying portion onto the length of the first layer 281 overlying portion covers substantially the whole of the length [symbol] of the first layer 281 overlying portion, it is more generally considered that embodiments where the projection of the second layer overlying portion 282 onto the length of the first layer 281 overlying portion(indicated in FIG. 1B by longitudinal axis X-X) covers at least the majority of the length of the first layer 281 overlying portion may be suitable in avoiding significant additional spreading resistance.

It will be appreciated that, in many cases, this requirement for such a degree of coverage of the length of first layer 281 overlying portion by the projection of the second layer 282 overlying portion will be a countervailing requirement to the requirement that the area of the second layer 282 overlying portion is a small minority of the area of the first layer 281.

The high degree of coverage of the length of first layer 281 overlying portion by the projection of the second layer 282 overlying portion in the example embodiment of FIGS. 1A-1E may be contrasted with the far smaller degree of coverage in the contrasting example of an actuator component of FIG. 3. As may be seen from FIG. 3, which is a plan view from above the piezoelectric actuating element 22 and membrane 20 of the actuator component, the second layer 282 overlying portion consists of two portions 282(1), 282(2) which may function in a similar manner to electrical vias, for example extending through a passivation layer (not shown) that overlies the piezoelectric actuating element 22. As may also be seen from FIG. 3, the two portions 282(1), 282(2) together have a considerably smaller area than that of the first layer 281 overlying portion (as viewed from the thickness direction).

Thus, similarly to the actuator component of FIGS. 1A-1E, in the actuator component of FIG. 3 the second layer overlying portion 282 has an area (as viewed from the thickness direction) that is a small fraction of the corresponding area of the first layer 281 overlying portion. Further, similarly to the actuator component of FIGS. 1A-1E, in the actuator component shown in FIG. 3, the first layer 281 overlying portion extends over substantially the whole of the top side of the piezoelectric member 24. However, in contrast to the actuator component of FIGS. 1A-1E, in the actuator component of FIG. 3, the projection of the second layer 282 overlying portion onto the length [symbol] of the first layer overlying portion 281 covers only a small minority of length [symbol] . The fractions of the length [symbol] covered by the projection of the second layer 282 overlying portion are illustrated in FIG. 3 by the bold lines running parallel to the double-headed arrow that indicates length [symbol] . As noted above, such a low degree of coverage may result in significant resistance arising from the current spreading from the second layer 282 to the first layer 281.

Returning now to the subject of the pattern of the second layer 282 overlying portion of the example embodiment of FIGS. 1A-1E, the inventors consider that, in general, the pattern should be shaped so as to accommodate flexing of the piezoelectric actuating element 22 when it is actuated. The inventors have determined that, in many cases, this may afford a particularly high level of efficiency to the piezoelectric actuating element 22 and thus may provide an actuator component 1 that is overall more efficient.

From the discussion above, it may be understood that in many cases it will be possible to provide an actuator component 1 with high efficiency and without significant additional resistance from current spreading from the second layer 282 to the first layer 281, provided that the second layer 282 overlying portion satisfies the following conditions:
1. It has an area (as viewed from the thickness direction) that is a small minority of the area of the first layer 281 overlying portion;
2. Its projection onto the length of the first layer 281 overlying portion in a length direction (a direction perpendicular to the thickness direction in which the extent of the first layer overlying portion is at or near a maximum) covers at least a majority of that length; and
3. It is formed as a pattern that is shaped so as to accommodate flexing of the piezoelectric actuating element 22 when it is actuated.

The inventors further consider that a high level of efficiency for the piezoelectric actuating element 22 may be afforded by accounting for the shape of the membrane 20, when deformed, in the selection of the pattern for the second layer 282 overlying portion. This may be considered an example of an approach to identify patterns satisfying condition (3) above. The pattern for the second layer 282 overlying portion of the actuator component of FIGS. 1A and 1B has been selected in such a manner, as may be appreciated with the aid of FIGS. 10 to 1E, which illustrate the shape of the membrane 20 when deformed by the piezoelectric actuating element 22.

In this regard, attention is firstly directed to FIG. 10, which is a cross-sectional view of the actuator component 1 of FIGS. 1A and 1B, taken perpendicular to the length of the chamber 10 at a location (shown in FIG. 1E) mid-way along the length of the chamber 10. For clarity, the piezoelectric actuating element 22 is shown as a single element in FIGS. 1C-1E, but it will be understood that its construction is the same as in FIGS. 1A and 1B and thus it includes lower electrode 26, piezoelectric member 24 and upper electrode 28, which in turn includes first layer 281 and second layer 282.

As discussed above, actuation of the piezoelectric actuating element 22 causes deformation of the membrane 20 that bounds chamber 10. The thus-deformed configuration of the membrane 20 is indicated in FIG. 10 by dashed line 20′. As may be seen, the greatest deflection of the membrane 20 is at the centre of the chamber 10, with the membrane deflection decreasing generally smoothly towards the sides of the chamber 10. In the specific example shown, the deflection is very roughly sinusoidal with respect to distance in the width direction of the chamber 10 (perpendicular to longitudinal axis X-X).

Attention is next directed to FIG. 1D, which is a cross-sectional view of the actuator component 1 of FIGS. 1A and 1B, taken along the longitudinal axis of the chamber 10 at a location (shown in FIG. 1E) mid-way across the width of the chamber 10. As may be seen, the greatest deflection of the membrane 20 is again at the centre of the chamber 10, with the membrane deflection decreasing generally smoothly towards the sides of the chamber 10. However, as may be appreciated by comparing FIG. 1D with FIG. 10, whereas the width deflection profile of the membrane 20 is very roughly sinusoidal, the length deflection profile includes a substantial proportion having approximately constant deflection.

Turning now to FIG. 1E, which is a plan view of the actuator component 1 shown in FIGS. 1A-1D from above the piezoelectric actuating element 22 and membrane 20, the deformation of membrane 20 is shown in still further detail. Specifically, contour lines 201, 202, 203 are shown, each of which indicates points on the membrane 20 that have the same amount of deflection in thickness direction T when the piezoelectric actuating element 22 is actuated. In this way, the slope of the membrane when deflected by actuation of the piezoelectric actuating element 22 may be better understood.

It is apparent from FIG. 1E that the elongate element 285 of the second layer 282 may be considered as following a path, specifically a straight-line path (extending horizontally in FIG. 1E). As is apparent from a comparison of FIGS. 10-1E with FIG. 1B, the path of the elongate element 285 extends generally perpendicular to the contours of deflection of the portion of the membrane 20 underlying the elongate element 285. This indicates that the path of the elongate element 285 generally follows or extends parallel to the slope of the membrane in its deflected state (i.e. when deflected by actuation of the piezoelectric actuating element 22). The inventors have determined that such a pattern for the second layer 282 overlying portion may afford a particularly high level of flexibility to the piezoelectric actuating element 22 and, in consequence, a high level of efficiency to the actuating element 22 and, in many cases, the actuator component 1 as a whole.

It is also apparent from FIG. 1E that the piezoelectric member 24 may likewise be considered as following a path, specifically a straight-line path (extending horizontally in FIG. 1E). More particularly, as is apparent from FIGS. 1B and 1E, the elongate element 285 is shaped such that it follows a path that is parallel to the path followed by the piezoelectric member 24. It is believed that this may assist in accommodating flexing of the piezoelectric actuating element 22 and thus in providing a high level of efficiency to the actuating element 22.

It should nonetheless be understood that FIGS. 1A-1E merely provide one example of a pattern for the second layer 282 overlying portion that is shaped so as to accommodate flexing of the piezoelectric actuating element 22 when it is actuated. Specifically, it should be noted that, in order to accommodate such flexing of the piezoelectric actuating element 22, it is by no means essential that the pattern for the second layer 282 consists of such an elongate element 285 (one that follows a path that extends: generally perpendicular to the contours of deflection of the portion of the membrane 20 underlying the elongate element 285; generally parallel to the slope of the membrane 20 in its deflected state; and/or generally parallel to the path followed by the piezoelectric member 24). Moreover, neither is it essential that the pattern consists of elongate elements: those skilled in the art will appreciate that a variety of patterns may fulfil the requirement of accommodating flexing of the piezoelectric actuating element 22 when it is actuated (provided that such patterns have an area, as viewed from the thickness direction T, that is a small minority of the area of the first layer 281 overlying portion).

While it may be noted that, in the example embodiment of FIGS. 1A and 1B, the second layer 282 overlying portion contacts the first layer 281 overlying portion over a contact area that is substantially equal to the area of the second layer 282 overlying portion (as viewed from the thickness direction T), it should be understood that this is not essential. Thus, in other examples, the second layer 282 overlying portion might contact the first layer 281 overlying portion over one or more contact regions, which have an area that is less than the area of the second layer 282 overlying portion (again, as viewed from the thickness direction T).

Such an example embodiment is shown in FIGS. 4A and 4B. Turning first to FIG. 4A, which shows an end view of a cross-section through the example embodiment of an actuator component 1, clearly visible are the chamber 10, membrane 20, piezoelectric member 24, and upper and lower electrodes 28, 26 of the actuator component 1. As with the example embodiment of FIGS. 1A-1E, the upper electrode 28 comprises a first layer 281 and a second layer 282, which include, respectively, a first layer 281 overlying portion and a second layer 282 overlying portion. Furthermore, the second layer 282 fulfils conditions (1)-(3) set out above with regard to the example embodiment of FIGS. 1A-1E. Accordingly, the actuator component 1 may operate with high efficiency and may not experience significant additional resistance from current spreading from the second layer 282 to the first layer 281.

Turning next to FIG. 4B, which is a plan view of the actuator component 1 shown in FIG. 4A, from above the piezoelectric actuating element 22 and membrane 20, the shapes of the upper electrode first layer 281 and second layer 282 may be more fully appreciated. As the first layer 281 extends over substantially the whole of the top side 241 of the piezoelectric member 24, only the chamfered sides of the piezoelectric member 24 are visible in the plan view of FIG. 4B.

From a comparison of FIG. 4A with FIG. 4B, it is apparent that the second layer 282 overlying portion contacts the first layer 281 overlying portion over a contact region 2811, which has an area (a “contact area”) that is less than the area of the second layer 282 overlying portion (as viewed from the thickness direction T). Nonetheless, in order to avoid significant spreading resistance between the first layer 281 and the second layer 282, it is considered that this contact area should generally be more than a quarter the area of the second layer 282 overlying portion.

FIG. 4B also shows how, in the particular example embodiment of FIGS. 4A and 4B, the upper electrode second layer 282 includes not only second layer 282 overlying portion (the portion that overlies both the first layer 281 overlying portion and the piezoelectric member 24), but also includes a further portion that extends over membrane 20, away from the piezoelectric member 24, and that is formed as a trace 32. This trace 32 may, for example, provide electrical connection of the upper electrode 28, and thus of the piezoelectric actuating element 22, to drive circuitry. Such a trace 32 may therefore be integrally formed and/or contiguous with the upper electrode second layer 282, which may provide reliable electrical connection to the piezoelectric actuating element 22.

Returning now to FIG. 4A, it is apparent that the actuator component 1 includes a passivation layer 29 that is disposed between the upper electrode first layer 281 and second layer 282. As may be seen, an aperture 291 (or window) is formed in the passivation layer 29, with a portion of the upper electrode second layer 282 extending through this aperture 291 so as to contact the upper electrode first layer 281 over the contact region 2811. The smaller area of the aperture 291 (as viewed from thickness direction T) and contact region 2811, as compared with the area of the second layer 282 overlying portion, is apparent from FIG. 4B.

As may also be seen from FIG. 4A, the passivation layer 29 extends over the sides of the piezoelectric member 24 (which in the particular example embodiment illustrated are chamfered) and the lower electrode 26, for example so as to protect and electrically isolate substantially the whole of the piezoelectric actuating element 22. While only one piezoelectric actuating element 22 is shown in FIGS. 4A and 4B, it will be understood that the actuator component will typically include an array comprising a large number of similar actuating elements 22; the same passivation layer 29 may similarly extend over the other piezoelectric actuating elements 22 within this array.

Further, while only one passivation layer is shown in FIGS. 4A and 4B, it should of course be understood that any suitable number of passivation layers might be employed. For instance, in addition to the passivation layer between the upper electrode first layer 281 and second layer 282, there could also be provided a further passivation layer that is disposed over the whole of the second layer 282, the whole of the first layer 281 and the piezoelectric member 24.

Furthermore, it should be understood that the example embodiment of FIGS. 1A-1E could similarly include one or more passivation layers. For instance, such passivation layer(s) could be disposed over the whole of the upper electrode second layer 282, and first layer 281 and the piezoelectric member 24 of each piezoelectric actuating element 22 within the actuator component 1.

In the example embodiments illustrated in FIGS. 1A-1E and 4A-4B, the upper electrode 28 is shown as being formed on the top side of the piezoelectric member 24. However, in other examples, one or more intervening layers might be provided between the upper electrode 28 and the top side 241 of the piezoelectric member 24. Such intervening layers may, for instance, include one or more adhesion layers.

Similarly, while in the example embodiment illustrated in FIG. 1A, the lower electrode 26 is shown as being formed on the bottom side 242 of the piezoelectric member, in other examples one or more intervening layers might be provided between the lower electrode 26 and the bottom side 242 of the piezoelectric member. Such intervening layers may, for instance, include one or more adhesion layers.

Further, while in the example embodiment of FIGS. 1A and 1B the piezoelectric member 24 and the first layer 281 are illustrated as being elongate in the length direction, this is not essential and in other embodiments (such as those shown in FIGS. 7A-7E, 8A-8B and 9A-9B) these may be differently shaped.

It will further be appreciated that, while only one fluid chamber 10 is shown in FIGS. 1A-1E and 4A-4B, there will typically be provided a large number of fluid chambers within an actuator component 1. Each fluid chamber will accordingly be provided with a respective nozzle and a respective piezoelectric actuating element, which is actuable to cause the ejection of fluid from the chamber in question through the corresponding one of the nozzles by deforming a membrane, which bounds, in part, the chamber in question. The chambers may, for example, be of generally like construction and may be provided side-by-side in a linear array.

As noted above with reference to FIGS. 1A-1E, a variety of patterns may fulfil the requirement of accommodating flexing of the piezoelectric actuating element 22 when it is actuated. In particular, while in the example embodiments of FIGS. 1A-1E and 4A-4B, the pattern of the second layer 282 overlying portion included only a single, generally rectangular elongate element 285, the pattern could be more complex. In this regard, attention is directed to FIGS. 5A-5D, which show a series of example embodiments of actuator components 1, each having a different pattern for the second layer 282 overlying portion.

While the following description of the example embodiments of FIGS. 5A-5D focuses on the pattern for the second layer 282 overlying portion and how this is shaped so as to accommodate flexing of the piezoelectric actuating element 22 when it is actuated—corresponding to condition (3) listed above—it should be appreciated that second layer 282 overlying portion is in each case further configured so as to fulfil the above-defined conditions (1) and (2) as well. Thus, in each case, the second layer 282 overlying portion: has an area (as viewed from the thickness direction) that is a small minority of the area of the first layer 281 overlying portion (condition 1); and its projection onto the length [symbol] of the first layer 281 overlying portion covers at least the majority of the length [symbol] of the first layer 281 overlying portion (condition 2). Accordingly, in each case, it is expected that the resulting actuator component 1 may operate with high efficiency and may not experience significant additional resistance from current spreading from the second layer 282 to the first layer 281.

Turning first to FIG. 5A, shown is an example embodiment in which the pattern consists of a single elongate element 285, as in the example embodiment of FIGS. 1A and 1B. As may be seen, the piezoelectric member 24 is elongate in a length direction, indicated by arrow [symbol] . As the first layer 281 (or, more specifically the overlying portion thereof) extends over substantially the whole of the top side 241 of the piezoelectric member 24, it is likewise elongate in the length direction. A width direction is defined perpendicular to this length direction (and also to the thickness direction T).

As may also be seen from FIG. 5A, in contrast to the example embodiment of FIGS. 1A and 1B, the width of the elongate element 285 shown in FIG. 5A decreases/tapers towards the longitudinal middle of the elongate element 285. Thus, the width w₂₂ of the elongate element 285 at its longitudinal ends is substantially greater than the corresponding width w₂₁ at its longitudinal middle. This tapering of the width of the elongate element 285 is considered to increase the flexibility of the piezoelectric actuating element 22 towards its longitudinal middle, which may in turn lead to greater displacement of the membrane 20 in some cases. In the specific example embodiment shown in FIG. 5A, the nozzle is also located opposite the longitudinal middle of the elongate element 285, so as to further benefit from the greater displacement of the centre of the membrane 20.

Turning next to FIG. 5B, shown is an example embodiment in which the pattern consists of a two elongate elements 285(1), 285(2). As with the example embodiment of FIG. 5A, the piezoelectric member 24 and the first layer 281 are each elongate in a length direction, indicated by arrow [symbol] . A width direction is defined perpendicular to this length direction (and also to the thickness direction T).

As may be seen from FIG. 5B, one of the elongate elements 285(1) extends from one longitudinal end, while the other elongate element 285(2) extends from the other longitudinal end. It may be further noted that each of the elongate elements 285(1), 285(2) stops short of the nozzle 18 (when viewed from the thickness direction T). There is thus a region 283 that, as viewed from the thickness direction T, overlaps with the nozzle 18 where the second layer 282 is not present.

Such a pattern for the second layer 282 of the upper electrode 28 is again considered to increase the flexibility of the piezoelectric actuating element 22 towards its longitudinal middle, which may in turn lead to greater displacement of the membrane 20.

As with the example embodiment shown in FIG. 5A, in the specific example embodiment illustrated in FIG. 5B, the nozzle is located opposite the longitudinal middle of the elongate element 285, so as to further benefit from the greater displacement of the centre of the membrane 20.

Turning now to FIG. 5C, shown is a further example embodiment in which the pattern consists of a two elongate elements 285(1), 285(2). As with the example embodiments of FIGS. 5A and 5B, the piezoelectric member 24 and the first layer 281 are each elongate in a length direction, indicated in FIG. 5C by arrow [symbol] A width direction is defined perpendicular to this length direction (and also to the thickness direction T).

In contrast to the example embodiment of FIG. 5B, the two elongate elements 285(1), 285(2) each extend substantially the full length of the first layer 281 and of the piezoelectric member 24 and are spaced apart in the width direction (perpendicular to the length direction and to the thickness direction T). Specifically, the two elongate elements 285(1), 285(2) are spaced apart a distance d, as indicated in FIG. 5C.

The effect of the spacing, d, in the width direction of these two elongate elements 285(1), 285(2) on the displacement of the membrane 20 was investigated through further modelling. The results of such modelling are shown in FIG. 6.

In this additional modelling experiment, a series of designs were investigated, the series including: an initial design generally similar to that shown in FIGS. 1A and 1B, with the pattern for the overlying portion of the second layer 282 consisting of a single elongate element 285 that was centrally located with respect to the width direction; and further designs where the two elongate elements 285(1), 285(2) were located at increasing distances, d, from each other.

As may be seen, the results indicate that increasing the spacing, d, of the two elongate elements 285(1), 285(2) from each other increases the amount of displacement of the membrane 20. Thus, it is expected that a high level of efficiency may be provided to the actuating element 22 where the two elongate elements 285(1), 285(2) are located at or adjacent to the edges of the piezoelectric member 24 with respect to the width direction.

Turning finally to FIG. 5D, shown is a still further example embodiment in which the pattern again consists of a two elongate elements 285(1), 285(2). As with the example embodiments of FIGS. 5A-5C, the piezoelectric member 24 and the first layer 281 are each elongate in a length direction, indicated in FIG. 5D by arrow [symbol] . A width direction is defined perpendicular to this length direction (and also to the thickness direction T).

The pattern shown in FIG. 5D may be considered as a combination of the approaches illustrated in FIGS. 5A and 5B, since one of the elongate elements 285(1) extends from one longitudinal end, while the other elongate element 285(2) extends from the other longitudinal end (as with the pattern of the example embodiment of FIG. 5B) and since the two elongate elements 285(1), 285(2) each decreases/tapers in width towards the longitudinal middle of the length of the first layer 281 and of the piezoelectric member 24. Thus, the width w₂₂ of each elongate element 285(1), 285(2) at the longitudinal end of the piezoelectric member 24 is substantially greater than the corresponding width w₂₁ at the longitudinal middle of the piezoelectric member 24.

Further, as with the example embodiment of FIG. 5B, each of the elongate elements 285(1), 285(2) stops short of the nozzle 18, with there thus being a region 283 that, as viewed from the thickness direction T, overlaps with the nozzle 18 where the second layer 282 is not present.

Such a pattern for the second layer 282 of the upper electrode 28 is again considered to increase the flexibility of the piezoelectric actuating element 22 towards its longitudinal middle, which may in turn lead to greater displacement of the membrane 20 in some cases.

It will be appreciated that further combinations of the approaches illustrated in FIGS. 5A-5D are of course possible. For instance, the approaches of FIGS. 5B and 5C might be combined, with each of a first group of elongate conductive members extending from a first longitudinal end of the piezoelectric member and each of a second group of elongate conductive members extending from a second, opposite longitudinal end of the piezoelectric member, with the members of each group being spaced apart in a width direction (perpendicular to the length direction and to the thickness direction).

By way of example, said first group of elongate conductive members may consist of a first pair of elongate conductive members, and said second group of elongate conductive members may consist of a second pair of elongate conductive members. The elongate conductive members of each of said first and said second pairs may be disposed on either side of an axis that extends in said length direction and that is centred on the piezoelectric member with respect to said width direction.

While in the example embodiments of FIGS. 1A-1B and 5A-5D the chamber 10, the piezoelectric member 24 and the first layer 281 overlying portion are illustrated as being elongate, this is not essential and in other embodiments these features may be differently shaped. In this regard, reference is directed to FIGS. 7A-7E, which illustrate a still further example embodiment of an actuator component 1, where the piezoelectric member 24 and the first layer 281 are annular.

As is apparent from a comparison of FIG. 7A with FIG. 7B, which are respectively a plan view of the actuator component 1 from above the piezoelectric actuating element 22 and a view of a cross-section through the fluid chamber of the actuator component 1, the fluid chamber 10 is generally cylindrical in shape, having a circular cross-section.

As in the example embodiments of FIGS. 1A-1E and 5A-5D, the upper electrode 28 includes two layers: a first layer 281, which is formed of a first conductive material (as discussed above with reference to the example embodiment of FIGS. 1A-1E), and a second layer 282, which is formed of a second conductive material (again, as discussed above with reference to the example embodiment of FIGS. 1A-1E).

As is apparent from FIG. 7B, the first and second layers 281, 282 are both annular, with the second layer 282 being disposed around the inner edge of the first layer 281. In view of the narrow radial extent of the annular shape of the second layer 282, the second layer 282 may be considered to have a pattern consisting of a single elongate element 285.

As with FIGS. 1A-1E, FIGS. 7A and 7B show the second layer 282 as being configured such that substantially the whole of it overlies both the first layer 281 and the piezoelectric member 24 (as viewed from the thickness direction T). As before, it should be appreciated that portions of the second layer 282 may extend beyond the first layer 281 (again, as viewed from said thickness direction T) and the piezoelectric member 24. Such portions may, for instance, join with traces 32 that extend over membrane 20 and provide electrical connection of the upper electrode 28, and thus of the piezoelectric member 24, to drive circuitry. As discussed above with reference to FIGS. 4A-4B, the second layer 282 may in some cases be integrally formed and/or contiguous with such traces 32.

Further, as with FIGS. 1A-1E, FIGS. 7A and 7B show the first layer 281 being configured such that substantially the whole of it overlies the piezoelectric member 24 (as viewed from the thickness direction T). However, it should be appreciated that, in other examples, portions of the first layer 281 could extend beyond the piezoelectric member 24 (again, as viewed from said thickness direction T). For instance, a portion of the first layer 281 might extend over part of the membrane 20 adjacent the piezoelectric member 24.

Nonetheless, as with previously described example embodiments, the inventors consider that the configuration of the first layer 281 overlying portion (that portion which overlies the piezoelectric member 24) relative to the second layer 282 overlying portion (that portion which overlies both the piezoelectric member 24 and the first layer 281 overlying portion) is of particular importance. More particularly, as with such previously described embodiments, it is proposed to configure the upper electrode 28 such that the area of the second layer 282 overlying portion is a small minority of the area of the first layer 281 overlying portion (condition (1), defined above). As before, it is considered that this may afford high efficiency to the actuating element 22.

Further, as with previously described embodiments, it is considered important that the second layer 282 overlying portion is configured such that its projection onto the length of the first layer 281 overlying portion covers at least a majority of the length of the first layer 281 overlying portion(condition (2), defined above).

Because the piezoelectric member 24 in the example embodiments of FIGS. 1A-1E, 4A-4B, and 5A-5D is elongate—and therefore the first layer 281 overlying portion is elongate in the same direction—it will be understood that in that case the first layer's length direction was its direction of elongation, its direction of maximum extent. However, in the example embodiment of FIGS. 7A-7E, the piezoelectric member 24 is annular; therefore, it has the same extent in every direction perpendicular to thickness direction T. This is apparent from FIG. 7A, which is a view along the thickness direction T, and which shows the piezoelectric member 24 as having the same extent in every direction in the plane of the page.

Because the piezoelectric member 24 has the same extent in every direction perpendicular to thickness direction T, the “length direction” for the first layer 281 overlying portion may be selected arbitrarily. (More generally, where the first layer 281 overlying portion is shaped such that, as viewed from the thickness direction T, it has an aspect ratio that is approximately equal to 1, the length direction may similarly be selected arbitrarily.)

FIG. 7A accordingly indicates the length [symbol] ₁ of the first layer 281 overlying portion in an arbitrarily-selected length direction of the first layer 281 overlying portion. Also indicated in FIG. 7B is the length [symbol] ₂ of the first layer 281 in a direction perpendicular to both this arbitrarily-selected length direction and to the thickness direction T, which direction could equally be selected as the length direction of the first layer 281 overlying portion. Where the length direction is defined in the direction of [symbol] ₁, a width direction may be defined in the direction of [symbol] ₂, and vice versa.

As is apparent from FIG. 7A, the projection of the second layer 282 overlying portion onto length [symbol] ₁ of the first layer 281 overlying portion covers the majority of length [symbol] ₁. As is also apparent from FIG. 7A, the projection of the second layer 282 overlying portion onto length [symbol] ₂ (which, as noted above is defined perpendicular to the direction of [symbol] ₁) of the first layer 281 overlying portion similarly covers the majority of length [symbol] ₂. In each case, the fractions of each length [symbol] ₁, [symbol] ₂ covered by the projection of the second layer 282 overlying portion are illustrated in FIG. 7A by bold lines.

A possible consequence of the projection of the second layer 282 overlying portion onto lengths defined in mutually perpendicular directions (each perpendicular to the thickness direction T) covering at least the majority of such mutually perpendicular lengths is that very little resistance results from current spreading from the second layer 282 to the first layer 281.

Turning next to FIG. 7C, shown is a perspective view of a section of the membrane 20 and actuating element 22 of the actuator component 1 of FIGS. 7A and 7B. More particularly, FIG. 7C illustrates the membrane in an unactuated state 20 and in an actuated state 20′. As is apparent, the centre of the membrane deflects downwardly in a generally circularly-symmetric fashion as a result of actuation of the piezoelectric actuating element 22.

As noted above, owing to the relatively narrow radial extent of the annular shape of the second layer 282, the second layer 282 may be considered to have a pattern consisting of a single elongate element 285. As is apparent from FIG. 7A, this elongate element 285 may be considered as following or extending along a path, specifically a circular path. Further, as may be appreciated from the shape of the membrane 20′ in its actuated shape, shown in FIG. 7C, the path that this elongate element 285 follows extends generally perpendicular to the slope of the membrane in its deflected state (i.e., when it is deflected by actuation of the piezoelectric actuating element 22). This may assist in accommodating flexing of the piezoelectric actuating element 22 when it is actuated (condition (3), defined above).

The shape of the membrane 20 of the actuator component 1 of the example embodiment of FIGS. 7A-7E, when deformed by the piezoelectric actuating element 22, may be better appreciated with the aid of FIGS. 7D and 7E.

In this regard, attention is firstly directed to FIG. 7D, which is a cross-sectional view of the actuator component 1 of FIGS. 7A-7C, taken perpendicular to the plane of membrane 20, through the centre of the chamber 10. For clarity, the piezoelectric actuating element 22 is shown as a single element in FIGS. 7D-7E, but it will be understood that its construction is the same as in FIGS. 7A-7C and thus it includes lower electrode 26, piezoelectric member 24 and upper electrode 28, which in turn includes first layer 281 and second layer 282. As discussed above, actuation of the piezoelectric actuating element 22 causes deformation of the membrane 20 that bounds chamber 10. The thus-deformed configuration of the membrane 20 is indicated in FIG. 7D by dashed line 20′. As may be seen, the greatest deflection of the membrane 20 is at the centre of the chamber 10, with the membrane deflection decreasing generally smoothly towards the sides of the chamber 10. In the specific example shown, the deflection is very roughly sinusoidal with respect to distance perpendicular to the thickness direction T.

Turning now to FIG. 7E, which is a plan view of the actuator component 1 shown in FIGS. 7A-7D, from above the piezoelectric actuating element 22 and membrane 20, the deformation of membrane 20 is shown in still further detail. Specifically, contour lines 201, 202, 203 are shown, each of which indicates points on the membrane 20 that have the same amount of deflection in thickness direction T when the piezoelectric actuating element 22 is actuated. In this way, the slope of the membrane when deflected by actuation of the piezoelectric actuating element 22 may be better understood.

As is apparent from a comparison of FIGS. 7D-7E with FIG. 7A, the elongate element 285 follows a path (specifically, a circular path) that extends generally parallel to the contours of deflection of the portion of the membrane 20 underlying the elongate element 285 (such contours of deflection also being circular in shape). Conversely, the elongate element 285 may be considered as following a path that is generally perpendicular to the slope of the membrane 20 in its deflected state (i.e. when deflected by actuation of the piezoelectric actuating element 22). The inventors have determined that such a pattern for the second layer 282 overlying portion may afford a particularly high level of flexibility to the piezoelectric actuating element 22 and, in consequence, a high level of efficiency to the actuating element 22 and, in many cases, the actuator component 1 as a whole.

It may further be noted that in the example embodiment of FIGS. 7A-7E, the elongate element 285 of the second layer 282 is shaped such that it generally follows a path (specifically, a circular path) that is parallel to the path followed by the piezoelectric member 24 (which is also circular). It is believed that this may assist in accommodating flexing of the piezoelectric actuating element 22 and thus in providing a high level of efficiency to the actuating element 22.

While in the example embodiments illustrated in FIGS. 7A-7E the second layer 282 is disposed around the inner edge of the first layer 281, in other embodiments the second layer 282 could instead be disposed around the outer edge of the first layer 281. Similar results in terms of the membrane displacement are expected for such an actuator component 1.

It may be noted that in the example embodiments illustrated in FIGS. 7A-7E, the upper electrode 28 is shown as being formed on the top side of the piezoelectric member 24. However, in other examples, one or more intervening layers might be provided between the upper electrode 28 and the top side 241 of the piezoelectric member 24. Such intervening layers may, for instance, include one or more adhesion layers.

Similarly, while in the example embodiment illustrated in FIGS. 7A-7E, the lower electrode 26 is shown as being formed on the bottom side 242 of the piezoelectric member, in other examples one or more intervening layers might be provided between the lower electrode 26 and the bottom side 242 of the piezoelectric member. Such intervening layers may, for instance, include one or more adhesion layers.

It will further be appreciated that, while only one fluid chamber 10 is shown in FIGS. 7A-7E, there will typically be provided a large number of fluid chambers within an actuator component 1. Each fluid chamber will accordingly be provided with a respective nozzle and a respective piezoelectric actuating element, which is actuable to cause the ejection of fluid from the chamber in question through the corresponding one of the nozzles by deforming a membrane, which bounds, in part, the chamber in question. The chambers may, for example, be of generally like construction and may be provided side-by-side in a linear array.

Furthermore, it should be understood that the example embodiment of FIGS. 7A-7E could include one or more passivation layers. For instance, such passivation layer(s) could be disposed over the whole of the upper electrode second layer 282, and first layer 281 and the piezoelectric member 24 of each piezoelectric actuating element 22 within the actuator component 1.

While in the example embodiment of FIGS. 7A-7E the second layer 282 overlying portion has been formed as a pattern consisting of an elongate element 285 that follows a path (specifically, a circular path) that extends generally parallel to the contours of deflection of the membrane 20 (and thus generally perpendicular to the slope of the membrane 20 in its deflected state), it should be understood that this is by no means essential. In this regard, attention is directed to FIGS. 8A-8B, which shows an example embodiment where the second layer 282 overlying portion has been formed as a pattern that includes elongate elements 285(1)-(8) that each extend generally perpendicular to the contours of deflection of the membrane 20 (and thus extend parallel to the slope of the membrane 20 in its deflected state). In this respect, the design of the second layer 282 overlying portion in the example embodiment of FIGS. 8A-8B is somewhat similar to that in the example embodiments of FIGS. 1A-1E, 4A-4B, 5A-6D. FIGS. 8A-8B are plan views taken from above the membrane of the actuator component.

The actuator component 1 of FIGS. 8A-8B is generally similar to the actuator component 1 of the example embodiment of FIGS. 7A-7E, except as described below. For instance, the fluid chamber 10 is generally cylindrical in shape, having a circular cross-section, and the upper electrode 28 includes a first layer 281 and a second layer 282. In particular, it should be understood that, in the example embodiment of FIGS. 8A-8B, the shape of the membrane 20 of the actuator component 1, when deformed by the piezoelectric actuating element 22, is generally similar to that illustrated in FIGS. 7C-7E.

Turning first to FIG. 8A it is apparent that, in the particular example embodiment shown, the second layer 282 overlying portion is formed as a pattern that consists of eight elongate elements 285(1)-285(8) (though it should be understood that any suitable number of elongate elements 285 could be employed). In the particular example embodiment shown, each of the elongate elements 285(1)-285(8) is wedge-shaped, but it will be understood that the elongate elements could be any suitable elongate shape.

More particularly, it may be noted that each of these elongate elements 285(1)-285(8) extends generally along a corresponding path, specifically a corresponding radial path. It will be understood that, as a result, the path of each of these elongate elements 285(1)-(8) is generally perpendicular to the contours of deflection of the portion of the membrane 20 underlying the elongate element in question, such contours being generally circular, as illustrated in FIG. 7E.

Conversely, each elongate element may be considered as following a path that is parallel to the slope of the membrane 20, when it is deflected by actuation of the piezoelectric actuating element 22. Thus, in the example embodiment of FIGS. 8A-8B, where the greatest deformation of the membrane is in the centre of the circular portion of the membrane 20 bounding the chamber 10, each elongate element follows a radial path.

The inventors have determined that such patterns for the second layer 282 overlying portion may afford a particularly high level of flexibility to the piezoelectric actuating element 22 and, in consequence, a high level of efficiency to the actuating element 22 and, in many cases, the actuator component 1 as a whole.

It should be appreciated that the patterns for the second layer 282 overlying portion illustrated in FIGS. 7A-7E and 8A-8B may be used in combination. FIGS. 9A-9B illustrate an example embodiment according to such an approach. As may be seen from the drawing, the second layer 282 overlying portion is formed as a pattern that consists of an annular elongate element 285(5) (in this case shown to follow the outer, rather than the inner, edge of the piezoelectric member, but still following a contour of degree of deflection) and four wedge-shaped elements 285(1)-285(4), each following a radial path. Thus, the pattern consists of a number of elongate elements, each of which follows a corresponding path that is either perpendicular or parallel to the contours of deflection of the portion of the membrane 20 underlying the elongate element 285 in question. Conversely, each path may be considered as being parallel or perpendicular, respectively, to the slope of the membrane 20 in its deflected state.

As the piezoelectric element 24 and the first layer 281 overlying portion in the example embodiments of FIGS. 8A-8B, and FIGS. 9A-9B is annular, the length direction may be selected arbitrarily, as with the example embodiment of FIGS. 7A-7E. Thus, FIGS. 8A-8B, and FIGS. 9A-9B indicate the length [symbol] ₁ of the first layer 281 overlying portion in such an arbitrarily-selected length direction for the first layer 281 overlying portion. FIGS. 8B and 9B then show, using bold lines, the fractions of the length [symbol] ₁ of the first layer 281 overlying portion in this length direction that are covered by the projection of the second layer 282 overlying portion. As is apparent, in each example embodiment, a majority of the length [symbol] ₁ of the first layer 281 overlying portion is covered, thus satisfying condition (2) defined above.

Indeed, it may be noted in the example embodiments of FIGS. 8A-8B and FIGS. 9A-9B that a majority of the length [symbol] ₂ of the first layer 281 overlying portion in a perpendicular direction is likewise covered by the projection of the second layer 282 overlying portion.

Furthermore, it should be understood that, in each of the example embodiments of FIGS. 8A-8B and 9A-9B, the area of the second layer 282 overlying portion is a small minority of the area of the first layer 281 overlying portion (condition (1), defined above). As noted above, this may afford high efficiency to the actuating element 22.

While in the example embodiments of FIGS. 7A-7E, 8A-8B and 9A-9B the fluid chamber 10 is described as being generally cylindrical in shape, having a circular cross-section, it should be appreciated that this is but one example of a suitable shape for the fluid chamber 10. For instance, the fluid chamber 10 might alternatively have an elliptical cross-section; indeed the cross-sectional shape of the chamber 10 may be any of a variety of closed curves.

As noted above, FIGS. 1, 4A-4B, 5A-5D, 7A-7E, 8A-8B and 9A-9B each show only one fluid chamber with one corresponding piezoelectric actuating element. As also pointed out above, there will typically be provided a large number of fluid chambers within an actuator component, with each fluid chamber being be provided with a respective nozzle and a respective piezoelectric actuating element. Furthermore, the actuator component may include a number of additional elements to those shown in FIGS. 1, 4A-4B, 5A-5D, 7A-7E, 8A-8B and 9A-9B. To aid the reader's understanding of how the chambers may be configured in an actuator component and what additional elements might be included, reference is directed to FIGS. 10A-10C.

Reference is firstly directed to FIG. 10A, which is a plan view of a cross-section taken along the length of a fluid chamber 10 of an example embodiment of an actuator component 1. The actuator component 1 of FIGS. 10A-10C may include an upper electrode having any of the constructions described with reference to FIGS. 1, 4A-4B, and 5A-5D above.

As may be seen from FIG. 10A, the example actuator component 1 includes a number of patterned layers that are stacked in a layering direction L (which in FIG. 10A is the vertical direction). As is also shown in FIG. 10A, each of the patterned layers extends in a plane perpendicular to the layering direction L.

In the particular actuator component 1 shown in FIG. 10A, the patterned layers include nozzle layer 4, fluid chamber substrate layer 2, membrane layer 20, wiring and passivation layers 30, and capping layer 40 (in that order). However, this particular combination of layers is by no means essential and, as will be explained in further detail below, additional layers may be included and/or certain layers may be omitted.

As may be seen from FIG. 10B, which is a cross-section taken in plane 10B indicated in FIG. 10A through fluid chamber substrate layer 2, a row of fluid chambers 10 is formed within the layers of the actuator component 1, with this row extending in a row direction R, which is substantially perpendicular to the layering direction. The row direction R is into the page in FIG. 10A.

As may also be seen from FIG. 10B, in the specific actuator component 1 of FIGS. 10A-10C, adjacent chambers within the row are separated by chamber walls 11. As shown in the drawing, the chambers 10 may be elongate in a direction perpendicular to the row direction R.

Also formed within the layers of the actuator component 1 are respective rows of inlet passageways 12 and outlet passageways 16, with each of these rows extending in the same row direction R as the row of fluid chambers 10. Thus, the rows of inlet passageways 12, outlet passageways 16 and fluid chambers 10 all extend parallel to one another.

Each inlet passageway 12 is fluidically connected so as to supply fluid to a respective one of the row of fluid chambers 10. Conversely, each outlet passageway 16 is fluidically connected so as to receive fluid from a respective one of the row of fluid chambers 10.

In the specific actuator component 1 of FIGS. 10A-10C, each inlet passageway 12 is fluidically connected to supply droplet fluid to one end of the corresponding one of the fluid chambers 10, whereas each outlet passageway 16 is fluidically connected to receive fluid from the other end of that fluid chamber 10.

In more detail, as is apparent from FIG. 10A, the inlet and outlet passageways 12 are fluidically connected to their corresponding ends of the fluid chamber 10 via respective flow restrictor passages 14a, 14b.

As shown in FIG. 10A, each of the fluid chambers 10 is provided with a respective nozzle 18 and a respective actuating element 22. As discussed above with reference to FIGS. 1, 4A-4B, 5A-5D, 7A-7C, 8A-8B and 9A-9B, the actuating element 22 is a piezoelectric actuating element and therefore includes a piezoelectric member 24.

As a result of the provision of inlet passageways 12 and outlet passageways 16, a droplet deposition head including an actuator component 1 such as that shown in FIGS. 10A-10C may be configured to operate in a recirculation mode, whereby a continuous flow of fluid through the head is established during use. For example, the resulting droplet deposition head may be provided with one or more fluid inlet ports and one or more fluid outlet ports for connection to a fluid supply system.

The resulting flow of fluid through the head may be continuous. More particularly, there may be established a continuous flow of fluid through each of the chambers 10 in the row. This flow may, depending on the configuration of the fluid supply system (e.g. the fluid pressures applied at the fluid inlet and fluid outlet), continue even during droplet ejection, albeit potentially at a lower flow rate.

In more detail, such a fluid supply system may, for instance, be configured to apply a positive pressure to the fluid at the fluid inlet port and a negative pressure to the fluid at the fluid outlet port, thereby drawing fluid through the head.

Regardless of the particular configuration of the fluid supply system, in a recirculation mode fluid may flow in parallel through each of the fluid inlet passageways 12, then (via the corresponding one of the flow restrictor passages 14a) through the corresponding one of the fluid chambers 10, past the respective one of the nozzles 18, and then through the corresponding one of the fluid outlet passageways 16 (via the corresponding one of the flow restrictor passages 14b).

It should further be appreciated that the actuator component 1 of FIGS. 10A-10C may be modified in a straightforward manner such that the outlet passageways 16 function as additional inlet passageways, with each chamber 10 thus being supplied with fluid by two respective inlet passageways. While the modifications to the actuator component that this would necessitate might be relatively minor, the other fluid supply components of the droplet deposition head, such as the manifold components, would in general differ more significantly, as compared with where the head was configured to operate in a recirculation mode.

Returning now to FIG. 10B, it is apparent from the drawing that each flow restrictor passage 14a, 14b presents a smaller cross-sectional area to flow as compared with the passages immediately adjacent to it. In the particular example shown, this is accomplished by each flow restrictor passage 14a, 14b having a smaller width perpendicular to the layering direction L as compared with the passages immediately adjacent to it. This approach to providing a reduced cross-section may be particularly appropriate as many techniques for forming patterned layers will provide greater control over features formed in the planes of the layers.

As is illustrated in FIG. 10A, in the particular design of an actuator component 1 of FIGS. 10A-10C each inlet passageway 12 extends through a number of layers within the actuator component 1, including: capping layer 40, wiring and passivation layers 30, membrane layer 20, and fluid chamber substrate layer 2. Similarly, each outlet passageway 16 extends through capping layer 40, wiring and passivation layers 30, membrane layer 20, and fluid chamber substrate layer 2.

Membrane layer 20 may therefore be considered as dividing each inlet passageway 12 into upper and lower portions (where the upper portion is that furthest from the nozzle layer 4 and the lower portion is that nearest to the nozzle layer 4) and each outlet passageway 16 into upper and lower respective portions (where, again, the upper portion 16 is that furthest from the nozzle layer 4 and the lower portion 16 is that nearest to the nozzle layer 4).

As is shown in FIG. 10A, in the particular example embodiment of an actuator component 1 of FIGS. 10A-10C each inlet passageway 12 is elongate in a direction that is generally parallel to the layering direction L. Similarly, each outlet passageway 16 is elongate in a direction generally parallel to the layering direction L.

However, this is not essential and in other examples the inlet and/or the outlet passageways could be elongate in other directions; for example, they may be elongate perpendicular to the layering direction.

More generally, where the inlet and/or the outlet passageways are elongate in a direction that is perpendicular to the row direction R, it may be possible to provide a compact structure, since their extent in the row direction R is small, thereby enabling the chambers to be closely spaced in the row direction R also.

In some cases, the surfaces of various features of the actuator component 1 may be coated with protective or functional materials, such as, for example, a suitable passivation or wetting material. For instance, such materials may be applied to the surfaces of those features that contact fluid during use, such as the inner surfaces of the inlet passageways 12, the outlet passageways 16, the fluid chambers 10 and/or the nozzles 18.

The fluid chamber substrate layer 2 shown in FIGS. 10A-10C may be formed of silicon (Si), and may for example be manufactured from a silicon wafer, whilst the features provided in the fluidic chamber substrate 2, including the fluid chambers 10, lower portions of inlet passageways 12(b), lower portions of outlet passageways 16(b), and flow restrictor passages 14a, 14b may be formed using any suitable fabrication process, e.g. an etching process, such as deep reactive ion etching (DRIE) or chemical etching. In some cases, the features of the fluid chamber substrate layer 2 may be formed from an additive process e.g. a chemical vapour deposition (CVD) technique (for example, plasma enhanced CVD (PECVD)), atomic layer deposition (ALD), or the features may be formed using a combination of etching and/or additive processes.

The nozzle layer 4 may comprise, for example, a metal (e.g. electroplated Ni), a semiconductor (e.g. silicon) an alloy, (e.g. stainless steel), a glass (e.g. SiO₂), a resin material or a polymer material (e.g. polyimide, SU8). In some cases, the nozzle layer 4 may be formed of the same material(s) as the fluid chamber substrate layer 2. Moreover, in some cases the features of the nozzle layer, including the nozzles 18, may be provided by the fluid chamber substrate layer 2, with the nozzle layer and fluid chamber substrate layer 2 being in effect combined into a single layer.

The nozzle layer 4 may, for example, have a thickness of between 10 μm and 200 μm (though for some applications a thickness outside this range may be appropriate).

The nozzles 18 may be formed in the nozzle layer 4 using any suitable process such as chemical etching, DRIE, or laser ablation.

In the example embodiment illustrated in FIG. 10A, the nozzle 18 is tapered such that its diameter decreases from its inlet to its outlet. The diameter of the nozzle outlet may, for example, be between 15 μm and 100 μm (though in some applications a diameter outside this range may be appropriate).

The taper angle of the nozzle 18 may be substantially constant, as shown in FIG. 1A, or may vary between the inlet and the outlet. For instance, the nozzle 18 may have a greater taper angle at its inlet than at its outlet (or vice versa).

As noted above, each actuating element 22 is actuable to cause the ejection of fluid from the corresponding one of the chambers 10 through the corresponding one of the nozzles 18. In the particular example shown in FIGS. 10A-10C, each actuating element 22 functions by deforming membrane layer 20.

The membrane layer 20 may comprise any suitable material, such as, for example, a metal, an alloy, a dielectric material and/or a semiconductor material. Examples of suitable materials include silicon nitride (Si₃N₄), silicon dioxide (SiO₂), aluminium oxide (Al₂O₃), titanium dioxide (TiO₂), silicon (Si) or silicon carbide (SiC). The membrane layer 20 may be formed using any suitable technique, such as, for example, ALD, sputtering, electrochemical processes and/or a CVD technique. The apertures corresponding to the inlet and outlet passageways 12, 16 may be provided in the membrane 20 for example by forming an initial layer of material, in which apertures are then etched or cut to form the patterned membrane layer 20, or by forming the apertures (and, optionally, other patterning) simultaneously with the membrane layer 20 using a patterning/masking technique.

The membrane 20 may be any suitable thickness as required by an application, such as between 0.3 μm and 10 μm. The selection of a suitable thickness may balance, on the one hand, the drive voltage required to obtain a certain amount of deformation of the membrane (since, in general, a thicker and therefore more rigid membrane will require a greater drive voltage to achieve a specific amount of deformation) and, on the other hand, the reliability and performance parameters of the device (as thinner membranes may have shorter lifetimes, for example as they may be more susceptible to cracking).

While only one membrane layer is illustrated in FIGS. 10A-10C, it should be noted that multiple membrane layers could be employed in other examples. The various membrane layers might be formed from different materials, for example so as to provide the membrane with mechanical robustness to fatigue. In the simplest case, the membrane may have a bilayer construction, but any suitable number of layers of different materials could be employed.

The membrane layer 20 faces the nozzle layer 4, with droplets being ejected in a direction normal to the plane of the membrane layer 20, that is to say, in a direction parallel to the layering direction L.

Such actuation may occur in response to the application of a drive waveform to the actuating element 22. In the example shown in FIGS. 10A-10C, such drive waveforms are received by two respective electrodes for each actuating element 22.

In more detail, actuating element 22 shown in FIGS. 10A and 10B includes a piezoelectric member 24, a lower electrode 26, and an upper electrode 28 (for example having a construction as described with reference to FIGS. 1, 4A-4B, and 5A-5D above).

The piezoelectric member 24 may, for example, comprise lead zirconate titanate (PZT), but any suitable piezoelectric material may be used.

The piezoelectric member 24 is generally planar, having opposing faces that extend normal to the layering direction L: the upper electrode 28 is provided on one of these faces and the lower electrode 26 is provided on the other. As may be seen from FIG. 10A, the lower electrode 26 is disposed between the piezoelectric member 24 and the membrane layer 20, whereas the upper electrode 28 overlies the piezoelectric member and faces towards a recess 42 defined within capping layer 40.

The capping layer 40 may define a single recess 42 for groups of, or all of the actuating elements, or may define a respective recess 42 for each actuating element 22. Such recesses 42 may be sealed in a fluid-tight manner so as to prevent fluid within the fluid chambers 10, inlet passageways 12 and outlet passageways 16 from entering.

The capping layer 40 shown in FIGS. 10A-10C may be formed of silicon (Si), and may for example be manufactured from a silicon wafer, whilst the features provided in the capping layer 40, including the recesses 42 and the upper portions of the inlet passageways 12 and of the outlet passageways 16 may be formed using any suitable fabrication process, e.g. an etching process, such as deep reactive ion etching (DRIE) or chemical etching. In some cases, at least a subset of features of the capping layer 40 may be formed from an additive process e.g. a CVD technique (for example, PECVD) etc. In still other cases, the features may be formed using a combination of etching and/or additive processes.

The piezoelectric member 24 may be provided on the lower electrode 26 using any suitable fabrication technique. For example, a sol-gel deposition technique, sputtering and/or ALD may be used to deposit successive layers of piezoelectric material on the lower electrode 26 to form the piezoelectric element 24.

As noted above, the lower electrode 26 and upper electrode 28 may comprise any suitable material, such as iridium (Ir), ruthenium (Ru), platinum (Pt), nickel (Ni) iridium oxide (Ir₂O₃), Ir₂O₃/Ir, aluminium (Al) and/or gold (Au). The lower electrode 26 and upper electrode 28 may be formed using any suitable techniques, such as, for example, a sputtering technique.

In order to provide drive waveforms to the actuating elements 22, the actuator component 1 includes a number of electrical traces 32a, 32b. Such traces electrically connect the upper 28 and/or lower 26 electrodes to drive circuitry (not shown) and may, for example, extend in a plane having a normal in the layering direction L.

In the actuator component 1 of FIGS. 10A-10C, these traces are provided as part of the wiring and passivation layers 30 and are provided on the membrane layer 20. However, in other examples the traces may be provided on other layers within an actuator component.

In the particular example embodiment illustrated in FIG. 10A, the upper electrodes 28 are electrically connected to electrical traces 32a, whereas the lower electrodes 26 are electrically connected to electrical traces 32b.

The electrical traces 32a/32b may, for example, have a thickness of between 0.01 μm and 10 μm, preferably between 0.1 μm and 2 μm, more preferably between 0.3 μm and 0.7 μm.

The electrical traces 32a/32b may be formed of any suitable conductive material, such as copper (Cu), gold (Ag), platinum (Pt), iridium (Ir), aluminium (Al), or titanium nitride (TiN).

At least one passivation layer 33b electrically isolates the traces 32b for the lower electrodes 26 from the traces 32a for the upper electrodes 28. At least one additional passivation layer 33a extends over the traces 32a for the upper electrodes 28 and may also extend over traces 32b for the lower electrodes 26.

Such passivation layers may protect the electrical traces 32a/32b from the environment to reduce oxidation of the electrical trace. In addition, or instead, they may protect the electrical traces 32a/32b from the droplet fluid during operation of the head, as contact between the traces and the fluid might cause short-circuiting to occur and/or may degrade the traces.

The passivation layers 33a/33b may comprise dielectric material so as to assist in electrically insulating the traces 32a/32b from each other.

The passivation layers 33a/33b may comprise any suitable material, such as SiO₂, Al₂O₃, ZrO₂, SiN, HfO₂.

Depending on the particular configuration of the traces 32a/32b and the passivation layers 33a/33b, the wiring and passivation layers 30 may further include electrical connections, such as electrical vias (not shown), to electrically connect the electrical traces 32a/32b with the electrodes 26/28 through the passivation layers 33a/33b.

The wiring and passivation layers 30 may also include adhesion materials (not shown) to provide improved bonding between, for example, any of: the electrical traces 32a/32b, the passivation layers 33a/33b, the electrodes 26, 28 and the membrane 20.

The wiring and passivation layers 30 (e.g. the electrical traces/passivation material/adhesion material etc.) may be provided using any suitable fabrication technique such as, for example, a deposition/machining technique, e.g. sputtering, CVD, PECVD, ALD, laser ablation etc. Furthermore, any suitable patterning technique may be used as required, such as photolithographic techniques (e.g. providing a mask during sputtering and/or etching).

Reference is now directed to FIG. 100, which is a plan view of the actuator component 1 from the side to which the capping layer 40 is attached, with the capping layer 40 removed so as to show clearly an illustrative configuration of the electrical traces 32 on membrane layer 20. In the illustrative configuration shown in FIG. 100, each actuating element 22 is electrically connected to two traces 32. In FIG. 100, the fluid chambers 10, flow restrictor passages 14a, 14b and nozzles 18, which are located on the far side of the membrane 20 in the view of FIG. 100, are depicted with dashed lines so as show clearly their orientations relative to the traces 32, inlet and outlet passageways 12,16 and the actuating elements 22.

As may be seen from FIG. 100, the traces 32 extend in a plane having a normal in the layering direction L. As is apparent from a comparison of FIG. 10A with FIG. 100, the inlet passageways 12 cross this plane, with each inlet passageway 12 passing between conductive traces 32. As FIG. 100 shows, one trace passes between each pair of neighbouring inlet passageways 12 (as the trace in question passes from one side of the row of inlet passageways 12 to the other). The outlet passageways 16 likewise cross this plane, with each outlet passageway 16 passing between conductive traces. As FIG. 100 shows, one trace 32 passes between each pair of neighbouring outlet passageways 16 (as the trace in question passes from one side of the row of outlet passageways 16 to the other).

The actuator component 1 shown in FIGS. 10A-10C may, for example, be fabricated using processes typically used to fabricate structures for Micro-Electro-Mechanical Systems (MEMS). In such cases, the actuator component 1 may be described as being a MEMS actuator component (it being noted that this carries with it no implication as to the type of actuating element utilised: for instance, actuator components with thermal actuating elements are referred to within the art as MEMS actuator components regardless of the fact that they do not include electromechanical actuating elements).

FIG. 10D illustrates a modified version 1′ of the actuator component 1 shown in FIGS. 10A-10C. More particularly, FIG. 10D is a plan view of a cross-section taken along the length of one of the chambers 10 of the modified actuator component 1′. As with the actuator component 1 of FIGS. 10A-10C, the modified version 1′ of FIG. 10D may include an upper electrode 28 having any of the constructions described with reference to FIGS. 1, 4A-4B, and 5A-5D above.

As is apparent from a comparison of FIG. 10D with FIG. 10A, the fluidic architecture of the actuator component 1 of FIGS. 10A-10C has been modified.

In more detail, in the actuator component 1 of FIGS. 10A-10C, an end of each of the inlet passageways 12 opens to the exterior of the actuator component 1. Thus, each inlet passageway 12 may receive fluid from exterior the actuator component, for example from a manifold component attached to the actuator component that forms part of the droplet deposition head, and convey it towards the fluid chambers 10. An end of each of the outlet passageways 16 similarly opens to the exterior of the actuator component 1. Thus, each outlet passageway 16 may convey fluid that it has received from the chambers 10 to exterior the actuator component, for example to the same (or an additional) manifold component attached to the actuator component 1 that forms part of the droplet deposition head.

In contrast, in the actuator component 1′ shown in FIG. 10D, there is formed an inlet port 15 that is fluidically connected at a first end to the exterior of the layers of the actuator component 1′, so as to receive fluid therefrom, and at a second end to each of the inlet passageways 12 within the row. The inlet port 15 is therefore elongate in the row direction R (into the page in FIG. 10D).

As may also be seen from FIG. 10D, there is formed in the actuator component 1′ an outlet port 19 that is fluidically connected at a first end to each of the outlet passageways 16 within the row, so as to receive fluid therefrom, and at a second end to the exterior of the layers of the actuator component 1′, so as to supply fluid thereto. The outlet port 19 is likewise elongate in the row direction R (into the page in FIG. 10D).

While in the particular example embodiment shown in FIG. 10D, the inlet port 15 and the outlet port 19 are formed in the capping layer 40, they could be formed in any suitable layer. For instance, an additional layer could be provided that overlies the capping layer 40, with the inlet port 15 and the outlet port 19 being provided substantially within this additional layer.

Further, while FIG. 10D illustrates the inlet port 15 and the outlet port 19 as extending only part-way into the capping layer 40 in the layering direction L, in other example embodiments either or both of the inlet port 15 and the outlet port 19 could extend through the entirety of the capping layer 40, for example all the way to the membrane layer 20.

While only one inlet port 15 is provided in the actuator component 1′ shown in FIG. 10D, with this inlet port 15 being common to all the inlet passageways 12, in other examples a number of inlet ports 15 could be provided, with each being connected to a corresponding group of inlet passageways 12 so as to supply fluid thereto.

In addition or instead, a number of outlet ports 19 could be provided (rather than just one common outlet port 19, as in FIG. 10D) with each being connected to corresponding group of outlet passageways 16, so as to receive fluid therefrom.

The actuator components described above with reference to FIGS. 1, 4A-4B, 5A-5D, 7A-7E, 8A-8B, 9A-9B and 10A-10D may, for example, be fabricated using processes typically used to fabricate structures for Micro-Electro-Mechanical Systems (MEMS). In such cases, the actuator components may be described as being MEMS actuator components (it being noted that this carries with it no implication as to the type of actuating element utilised: for instance, actuator components with thermal actuating elements are referred to within the art as MEMS actuator components regardless of the fact that they do not include electromechanical actuating elements).

Though the foregoing description has presented a number of examples, it should be understood that other examples and variations are contemplated within the scope of the appended claims.

It should be noted that the foregoing description is intended to provide a number of non-limiting examples that assist the skilled reader's understanding of the present invention and that demonstrate how the present invention may be implemented.

1.-24. (canceled)

25. An actuator component for a droplet deposition head, comprising:
a plurality of fluid chambers, each fluid chamber being provided with a respective nozzle and a respective piezoelectric actuating element, which is actuable to cause the ejection of fluid from a corresponding chamber through a respective nozzle by deforming a membrane, which bounds, in part, the corresponding chamber;
wherein each piezoelectric actuating element comprises:
a piezoelectric member having a top side and an opposing bottom side, the bottom side being nearest to the membrane, the top and bottom sides being spaced apart in a thickness direction;
a lower electrode, disposed adjacent the bottom side of the piezoelectric member;
an upper electrode, disposed adjacent the top side of the piezoelectric member;
wherein each upper electrode comprises:
a first layer, which is formed of a first conductive material;
a second layer, which is formed of a second conductive material, the first layer being disposed between the second layer and the piezoelectric member;
wherein at least a portion of the first layer is overlying the piezoelectric member when viewed from the thickness direction, the overlying portion of the first layer extending over substantially the whole of the top side of the piezoelectric member and having a length in a length direction, which is a direction perpendicular to the thickness direction, wherein the overlying portion of the first layer extending over substantially the whole of the top side of the piezoelectric member is at or near a maximum when viewed from the thickness direction;
wherein at least a portion of the second layer is overlying both the first layer and the piezoelectric member when viewed from the thickness direction, the overlying portion of the second layer being formed as a pattern that is shaped so as to accommodate flexing of the piezoelectric actuating element when it is actuated;
wherein, as viewed from the thickness direction, an area of the overlying portion of the second layer is substantially less than half that of an area of the overlying portion of the first layer;
wherein the overlying portion of the second layer projects on to the length of the overlying portion of the first layer;
wherein a projection of the overlying portion of the second layer covers at least a majority of the length of the overlying portion of the first layer;
and wherein:
the pattern comprises one or more elongate elements;
each piezoelectric member and each overlying portion of the first layer elongates in the length direction, thus defining a width direction, which is perpendicular to the length direction and to the thickness direction; and
each piezoelectric member comprises one or more elongate conductive members comprising: a first group of one or more elongate conductive members and a second group of one or more elongate conductive members, each of the first group of elongate conductive members extending from a first longitudinal end of the corresponding piezoelectric member and each of the second group of elongate conductive members extending from a second, opposite longitudinal end of the corresponding piezoelectric member.

26. An actuator component according to claim 25, wherein the overlying portion of the second layer contacts the first layer over one or more contact regions, which have, in combination, a contact area; and
wherein the contact area is more than one quarter of the area of the overlying portion of the second layer, as viewed from the thickness direction.

27. An actuator component according to claim 25, wherein the overlying portion of the second layer contacts the first layer over one or more contact regions; and
wherein the projection of the contact regions onto the length of the overlying portion of the first layer covers at least a majority of the length of the first layer.

28. An actuator component according to claim 25, wherein the elongate elements are spaced apart from each other.

29. An actuator component according to claim 25, wherein each of the elongate elements is shaped such that it follows a path that is generally perpendicular to a slope of the membrane when deflected by actuation of the piezoelectric actuating element.

30. An actuator component according to claim 25, wherein each of the elongate elements is shaped such that it follows a path that is generally parallel to contours of deflection of a portion of the membrane that a corresponding elongate member overlies.

31. An actuator component according to claim 25, wherein shapes of each piezoelectric member generally follows a corresponding path; and
wherein at least some of the one or more elongate elements each follow a path that is parallel to a path of the corresponding piezoelectric member.

32. An actuator component according to claim 25, wherein the first group of elongate conductive members consists of a first pair of elongate conductive members and the second group of elongate conductive members consists of a second pair of elongate conductive members.

33. An actuator component according to claim 25, wherein the one or more elongate conductive members for each piezoelectric member are shaped such that their combined width in the width direction decreases towards the longitudinal center of a corresponding piezoelectric member.

34. An actuator component according to claim 25, wherein each of the one or more elongate conductive members for each piezoelectric member is shaped such its width in the width direction decreases towards the longitudinal center of a corresponding piezoelectric member.

35. An actuator component according to claim 25, wherein one or more of the elongate conductive members stops short of the nozzle of the corresponding chamber, with respect to the length direction.

36. An actuator component according to claim 25, wherein the second conductive material has greater conductivity than the first conductive material.

37. An actuator component according to claim 25, further comprising a plurality of traces, which provide electrical connection of the piezoelectric actuating elements to a drive circuitry, wherein the second layer of each piezoelectric actuating element is contiguous with one or more of the plurality of traces.

38. An actuator component according to claim 25, further comprising
one or more passivation layers,
wherein the one or more passivation layers are disposed between the first layer and the second layer of each piezoelectric actuating element; and
wherein a plurality of apertures are formed in the one or more passivation layers, and, for each piezoelectric actuating element, one or more portions of the second layer extend through one or more of the apertures so as to contact a corresponding first layer.

39. An actuator component according to claim 38, wherein a respective aperture is provided for each elongate element.

40. An actuator component according to claim 25, wherein the overlying portion of the first layer has a width in a width direction, which is perpendicular to the thickness direction and the length direction; and
wherein the projection of the overlying portion of the second layer onto the width covers at least a majority of the width.

41. An actuator component according to claim 25, wherein each piezoelectric actuating element comprises a region where the first layer is not present, and
wherein the region, as viewed from the thickness direction, overlaps with a corresponding nozzle.

42. An actuator component according to claim 25, wherein the area of the overlying portion of the second layer is less than one fifth of the area of the first layer overlying portion.

43. An actuator component according to claim 25, wherein the second layer is substantially thicker in said thickness direction than said first layer.

44. A droplet deposition head comprising an actuator component wherein the actuator component comprises:
a plurality of fluid chambers, each fluid chamber being provided with a respective nozzle and a respective piezoelectric actuating element, which is actuable to cause the ejection of fluid from a corresponding chamber through the a respective nozzle by deforming a membrane, which bounds, in part, the corresponding chamber;
wherein each piezoelectric actuating element comprises:
a piezoelectric member having a top side and an opposing bottom side, the bottom side being nearest to the membrane, the top and bottom sides being spaced apart in a thickness direction;
a lower electrode, disposed adjacent the bottom side of the piezoelectric member;
an upper electrode, disposed adjacent the top side of the piezoelectric member;
wherein each upper electrode comprises:
a first layer, which is formed of a first conductive material;
a second layer, which is formed of a second conductive material, the first layer being disposed between the second layer and the piezoelectric member;
wherein at least a portion of the first layer is overlying the piezoelectric member when viewed from the thickness direction, the overlying portion of the first layer extending over substantially the whole of the top side of the piezoelectric member and having a length in a length direction, which is a direction perpendicular to the thickness direction, wherein the overlying portion of the first layer extending over substantially the whole of the top side of the piezoelectric member is at or near a maximum when viewed from the thickness direction;
wherein at least a portion of the second layer is overlying both the first layer and the piezoelectric member when viewed from the thickness direction, the overlying portion of the second layer being formed as a pattern that is shaped so as to accommodate flexing of the piezoelectric actuating element when it is actuated;
wherein, as viewed from the thickness direction, an area of the overlying portion of the second layer is substantially less than half that of an area of the overlying portion of the first layer;
wherein the overlying portion of the second layer projects onto the length of the overlying portion of the first layer;
wherein the projection of the overlying portion of the second layer covers at least a majority of the length of the overlying portion of the first layer;
and wherein:
the pattern comprises one or more elongate elements;
each piezoelectric member and each overlying portion of the first layer elongates in the length direction defining a width direction, which is perpendicular to the length direction and to the thickness direction; and
each piezoelectric member comprises one or more elongate conductive members: a first group of one or more elongate conductive members and a second group of one or more elongate conductive members, each of the first group of elongate conductive members extending from a first longitudinal end of the corresponding piezoelectric member and each of the second group of elongate conductive members extending from a second, opposite longitudinal end of the corresponding piezoelectric member.
